(19) United States
(12) Patent Application Publication
(10) Pub. No.: US 2026/0228044 A1
(43) Pub. Date: Aug. 6, 2026

(54) HARDWARE RESOURCE RESERVATION IN A RECONFIGURABLE DATAFLOW ARCHITECTURE

(71) Applicant: SambaNova Systems, Inc., Palo Alto, CA (US)

(72) Inventors: Pushkar Shridhar NANDKAR, Hayward, CA (US); Raghunath SHENBAGAM, San Ramon, CA (US)

(73) Assignee: SambaNova Systems, Inc., Palo Alto, CA (US)

(21) Appl. No.: 19/042,467

(22) Filed: Jan. 31, 2025

(51) Int. Cl. G06F 9/50

(52) U.S. Cl. CPC G06F 9/5016; G06F 9/5033; G06F 9/505

(57) ABSTRACT

A system includes a first RDU including a local interconnect usable for coupling to a second RDU, a host coupled to the first RDU using a system interconnect coupled to the local interconnect, and a local memory on the host. The system interconnect is accessed by an RDRT driver running on the host. The RDRT driver may record a workload reservation specifying an RDU resource usable to execute a workload, selected from: an RDU tile, a local host memory, an HBM, a DDR memory, or a peripheral port. The reservation specifies a condition of shared accessibility, exclusive accessibility, or allowed substitution of the RDU resource with a second RDU resource. The workload can include an AI/ML application for execution by the system.

### BACKGROUND

### Field of the Disclosure

The present disclosure relates generally to a reconfigurable dataflow architecture and, more particularly, to methods and systems for hardware resource reservation in a reconfigurable dataflow architecture.

### Description of the Related Art

Data processing and computer science have seen a revolution in learning capability and performance with the advent of artificial intelligence (AI) and machine learning (ML) based on neural networks (NN) as a core topology using parallel processing algorithms. Many AI/ML applications have been performed by conventional computer architectures based on sequential control flow, in which an instruction set is sequentially executed by a central processing unit (CPU). However, very large AI/ML workloads, such as involved with large language models (LLMs), may not be particularly well matched with the capabilities of CPU based computer system.

Therefore, in addition to the CPU, computer systems including a graphics processing unit (GPU) have been used to accelerate the parallel processing involved with AI/ML workloads. GPUs that were designed to accelerate graphics output to a display were found to also accelerate the AI/ML workloads in a similar manner. The use of CPU/GPU computer systems may provide a limited potential for acceleration of AI/ML workloads, and in particular very large AI/ML workloads, due to constraints with memory access as well as due to overall power consumption, which can be undesirable.

### SUMMARY

In one aspect, a first system for hardware resource reservation in a reconfigurable dataflow architecture is disclosed. The first system may include a first reconfigurable dataflow unit (RDU) including a local interconnect usable for coupling to a second RDU and a host coupled to the first RDU using a first system interconnect coupled to the local interconnect, where the first system interconnect is accessed by a reconfigurable dataflow runtime (RDRT) driver executing under an operating first system running on the host. The first system may also include a local memory on the host. In the first system, the RDRT driver may be configured to record a workload reservation specifying an RDU resource usable to execute a workload by the first system, the RDU resource selected from: an RDU tile including multiple pattern compute units (PCUs), a local memory at the host, a high-bandwidth memory (HBM), a dual data rate (DDR) memory module pair, or a peripheral port. In the first system, the workload reservation may specify at least one condition selected from: shared accessibility of the RDU resource, exclusive accessibility of the RDU resource, or allowed substitution of the RDU resource with a second RDU resource included in the first system. In the first system, the workload may include an AI/ML application for execution using the first system.

In any of the disclosed embodiments of the first system, the RDRT driver may be further configured to receive a first indication for at least partial execution of the workload using the first RDU. In the first system, responsive to receiving the first indication, the RDRT driver may be further configured to record the workload reservation specifying that the RDU resource includes an RDU tile included in the first RDU, and a first memory selected from at least one of: the local memory, a DDR memory module pair, or an HBM.

In any of the disclosed embodiments, the first system may include a first RDU tile and a second RDU tile included with the first RDU, a first set of DDR memory module pairs included with the first RDU, a first HBM and a second HBM included with the first RDU, a first plurality of peripheral ports included with the local interconnect in the first RDU, a second plurality of peripheral ports included with the local interconnect in the second RDU, a third RDU tile and a fourth RDU tile included in the second RDU, a second set of DDR memory module pairs included with the second RDU, and a third HBM and a fourth HBM included with the second RDU. In the first system, the RDRT driver may be configured to receive a second indication for at least partial execution of the workload using the first RDU and using the second RDU. Responsive to receiving the second indication, the RDRT driver may be configured to record the workload reservation specifying that the RDU resource includes an RDU tile included in the first RDU or in the second RDU, a pair of peripheral ports including one of the first plurality of peripheral ports and one of the second plurality of peripheral ports, and a second memory. In the first system, the second memory may be selected from at least one of the local memory, a DDR memory module pair included with the first RDU or the second RDU, or an HBM included with the first RDU or the second RDU.

In any of the disclosed embodiments of the first system, the first RDU may further include a first RDU die including the first RDU tile, the second RDU tile, about one half of the first plurality of peripheral ports, a first HBM controller controlling the first HBM, a second HBM controller controlling the second HBM, and a first set of DDR controllers respectively controlling about one half of the first set of DDR memory module pairs.

In any of the disclosed embodiments of the first system, first RDU may further include a second RDU die linked to the first RDU die with a die-to-die (D2D) interface. In the first system, the second RDU die may include corresponding components as the first RDU die, or the first RDU die may be identical to the second RDU die.

In any of the disclosed embodiments of the first system, the shared accessibility of the RDU resource may specify sharing of the RDU resource among the workload and a second workload concurrently executing on the first system. In any of the disclosed embodiments of the first system, the exclusive accessibility of the RDU resource may specify that a second workload for execution on the first system, concurrently to the workload, will be denied access to the RDU resource.

In another aspect, a first method for hardware resource reservation in a reconfigurable dataflow architecture is disclosed. The first method may include receiving, at an RDRT driver, a first indication of a first workload for at least partial execution using an RDU system including a first RDU. In the first method, the RDRT driver may execute on an operating system executing on a host coupled to the first RDU using a system interconnect. Responsive to receiving the first indication, the first method may also include recording a workload reservation specifying an RDU resource in the RDU system for execution of the first workload, the RDU resource selected from an RDU tile including multiple pattern compute units (PCUs), a local memory at the host, a high-bandwidth memory (HBM), a dual data rate (DDR) memory module pair, or a peripheral port. In the first method, the workload reservation may specify at least one condition selected from shared accessibility of the RDU resource, exclusive accessibility of the RDU resource, or allowed substitution of the RDU resource with a second RDU resource. In the first method, the first workload may include an AI/ML application for execution using the RDU system.

In any of the disclosed embodiments, the first method may include recording the workload reservation specifying a first set of RDU resources including an RDU tile included in the first RDU, or a first workload memory selected from at least one of: a local memory on the host, a first DDR memory module pair included with the first RDU, or a first HBM included with the first RDU. The first method may also include initiating execution of the first workload using at least the first RDU and the first set of RDU resources.

In any of the disclosed embodiments of the first method, the first RDU may further include a first plurality of peripheral ports included in a local interconnect coupled to the system interconnect, while the first method may further include receiving, at the RDRT driver, a second indication of the first workload for execution using the first RDU and using a second RDU coupled with the first RDU using the local interconnect. Responsive to receiving the second indication, the first method may further include recording the workload reservation specifying a second set of RDU resources including an RDU tile included in the first RDU or in the second RDU, a second workload memory, or a pair of peripheral ports consisting of one of the first plurality of peripheral ports coupled to one of a second plurality of peripheral ports included with the local interconnect in the second RDU. In the first method, the second workload memory may be selected from at least one of the local memory, a second DDR memory module pair included with the first RDU or the second RDU, or a second HBM included with the first RDU or the second RDU. The first method may further include initiating execution of the first workload according to the workload reservation using the first RDU, the second RDU, and the second set of RDU resources.

In any of the disclosed embodiments of the first method, the first RDU may further include a first RDU die including a first RDU tile, a second RDU tile, about one half of the first plurality peripheral ports, a first HBM controller, a second HBM controller, and a first set of DDR controllers respectively controlling about one half of the first set of DDR memory module pairs.

In any of the disclosed embodiments of the first method, the first RDU may further include a second RDU die linked to the first RDU die with a die-to-die (D2D) interface. In the first method, the second RDU die may include corresponding components as the first RDU die, or the second RDU die may be identical to the first RDU die.

In any of the disclosed embodiments of the first method, recording the workload reservation specifying the shared accessibility of the RDU resource may further include recording the workload reservation specifying sharing of the RDU resource among the first workload and a second workload concurrently executing on the RDU system.

In any of the disclosed embodiments of the first method, recording the workload reservation specifying the exclusive accessibility of the RDU resource may further include recording the workload reservation specifying that a second workload for execution on the system, concurrently to the first workload, will be denied access to the RDU resource.

In a further aspect, a first computer-readable media storing instructions executable by a computer system is disclosed. In the first computer-readable media, the instructions may be executable to receive, at an RDRT driver, a first indication of a first workload for at least partial execution using an RDU system including a first RDU, such that the RDRT driver executes on an operating system executing on a host coupled to the first RDU using a system interconnect. Responsive to receiving the first indication, the instructions in the first computer-readable media may be executable to record a workload reservation specifying an RDU resource in the RDU system for execution of the first workload, the RDU resource selected from an RDU tile including multiple pattern compute units (PCUs), a local memory at the host, an HBM, a DDR memory module pair, or a peripheral port. According to the instructions in the first computer-readable media, the workload reservation may specify at least one condition selected from shared accessibility of the RDU resource, exclusive accessibility of the RDU resource, or allowed substitution of the RDU resource with a second RDU resource. According to the instructions in the first computer-readable media, the first workload may include an AI/ML application for execution using the RDU system.

In any of the disclosed embodiments of the first computer-readable media, the instructions may be executable to record the workload reservation specifying a first set of RDU resources and initiating execution of the first workload using the first RDU and the first set of RDU resources. According to the instructions in the first computer-readable media, the first set of RDU resources may include an RDU tile included in the first RDU, or a first workload memory selected from at least one of: a local memory on the host, at least one first DDR memory module pairs included with the first RDU, or a first HBM included with the first RDU.

In any of the disclosed embodiments of the first computer-readable media, the first RDU may further include a first plurality of peripheral ports included in a local interconnect coupled to the system interconnect, the instructions in the first computer-readable media may be executable to receive, at the RDRT driver, a second indication of the workload for execution using the first RDU and using a second RDU coupled with the first RDU using the local interconnect. Responsive to receiving the second indication, the instructions in the first computer-readable media may be executable to record the workload reservation specifying a second set of RDU resources including an RDU tile included in the first RDU or in the second RDU, a second workload memory, or a pair of peripheral ports consisting of one of the first plurality of peripheral ports coupled to one of a second plurality of peripheral ports included with the local interconnect in the second RDU. According to the instructions in the first computer-readable media, the second workload memory may be selected from at least one of the local memory, a second DDR memory module pair included with the first RDU or the second RDU, or a second HBM included with the first RDU or the second RDU. The instructions in the first computer-readable media may be executable to initiate execution of the first workload according to the workload reservation using the first RDU, the second RDU, and the second set of RDU resources.

In any of the disclosed embodiments of the first computer-readable media, the first RDU may further include a first RDU die including a first RDU tile, a second RDU tile, about one half of the first plurality peripheral ports, a first HBM controller, a second HBM controller, and a first set of DDR controllers respectively controlling about one half of the first set of DDR memory module pairs. According to the instructions in the first computer-readable media, the first RDU may further include a second RDU die linked to the first RDU die with a D2D interface, such that the second RDU die includes corresponding components as the first RDU die, or the first RDU die is identical to the second RDU die.

In any of the disclosed embodiments of the first computer-readable media, the instructions to record the workload reservation specifying the shared accessibility of the RDU resource may further include instructions to record the workload reservation specifying sharing of the RDU resource among the first workload and a second workload concurrently executing on the RDU system.

In any of the disclosed embodiments of the first computer-readable media, the instructions to record the workload reservation specifying the exclusive accessibility of the RDU resource may further include instructions to record the workload reservation specifying that a second workload for execution on the RDU system, concurrently to the first workload, will be denied access to the RDU resource.

In another aspect, a second system for workload resource reservation in a reconfigurable dataflow architecture is disclosed. The second system may include an RDU system having a local interconnect and configured to receive workloads for execution from a host via a system interconnect coupled to the local interconnect. The second system may further include an RDRT architecture executing on the host and configured to receive a first workload for execution on the RDU system, including receiving a first workload reservation specifying a first RDU resource included in the RDU system, determine an access condition for the first RDU resource selected from: shared accessibility, exclusive accessibility, or allowed substitution, and initiate execution of the first workload according to the first workload reservation and the access condition. The first RDU resource may be selected from an RDU tile including multiple pattern compute units (PCUs), a local memory at the host, an HBM, a DDR memory module pair, or a peripheral port.

In any of the disclosed embodiments of the second system, the RDRT architecture may further be configured to, during execution of the first workload on the RDU system, receive a second workload for execution on the RDU system, including receiving a second workload reservation for the second workload specifying a second RDU resource. In the second system, the RDRT architecture may further be configured to, when the second RDU resource corresponds to the first RDU resource, determine, based on the access condition, whether the second workload can use the second RDU resource.

In any of the disclosed embodiments of the second system, the RDRT architecture may further be configured to, when the access condition for the first RDU resource is shared accessibility, allow the second workload to share the second RDU resource with the first RDU resource and initiate execution of the second workload according to the second workload reservation.

In any of the disclosed embodiments of the second system, the RDRT architecture may further be configured to, when the access condition for the first RDU resource is exclusive accessibility, prevent the second workload from executing on the RDU system.

In any of the disclosed embodiments of the second system, the RDRT architecture may further be configured to, when the access condition for the first RDU resource includes allowed substitution, determine a third RDU resource corresponding to the second RDU resource if the second RDU resource is unavailable, such that the third RDU resource may be available for the second workload, substitute the third RDU resource for the second RDU resource in the second workload reservation, initiate execution of the second workload according to the second workload reservation.

In any of the disclosed embodiments of the second system, the first workload may include an executable file that generates bitfiles and argument tables, and may further include segments of model data that cumulatively describe an AI/ML application corresponding to the first workload.

In any of the disclosed embodiments of the second system, the first workload reservation may specify a first RDU memory resource for the bitfiles, a second RDU memory resource for the argument tables, and a third RDU memory resource for the segments of model data. In the second system, the first RDU memory resource, the second RDU memory resource, and the third RDU memory resource may be selected from the local memory at the host, the HBM, or the DDR memory module pair.

In a further aspect, a second method for workload resource reservation in a reconfigurable dataflow architecture is disclosed. The second method may include receiving a first workload for execution on an RDU system, including receiving a first workload reservation specifying a first RDU resource included in the RDU system. In the second method, the first RDU resource may be selected from an RDU tile including multiple PCUs, a local memory at a host, an HBM, a DDR memory module pair, or a peripheral port. The second method may include determining an access condition for the first RDU resource selected from shared accessibility, exclusive accessibility, or allowed substitution. The second method may include initiating execution of the first workload according to the first workload reservation and the access condition, such that the RDU system includes a local interconnect and is configured to receive workloads for execution from the host via a system interconnect coupled to the local interconnect.

In any of the disclosed embodiments, the second method may further include, during execution of the first workload on the RDU system, receiving a second workload for execution on the RDU system, including receiving a second workload reservation for the second workload specifying a second RDU resource. When the second RDU resource corresponds to the first RDU resource, the second method may further include determining, based on the access condition, whether the second workload can use the second RDU resource.

In any of the disclosed embodiments, the second method may further include, when the access condition for the first RDU resource is shared accessibility, allowing the second workload to share the second RDU resource with the first RDU resource, and initiating execution of the second workload according to the second workload reservation.

In any of the disclosed embodiments, the second method may further include, when the access condition for the first RDU resource is exclusive accessibility, preventing the second workload from executing on the RDU system.

In any of the disclosed embodiments, the second method may further include, when the access condition for the first RDU resource includes allowed substitution, determining a third RDU resource corresponding to the second RDU resource if the second RDU resource is unavailable, such that the third RDU resource may be available for the second workload. The second method may further include substituting the third RDU resource for the second RDU resource in the second workload reservation, and initiating execution of the second workload according to the second workload reservation.

In any of the disclosed embodiments of the second method, the first workload may include an executable file that generates bitfiles and argument tables, and may further include segments of model data that cumulatively describe an AI/ML application corresponding to the first workload.

In any of the disclosed embodiments of the second method, the first workload reservation may specify a first RDU memory resource for the bitfiles, a second RDU memory resource for the argument tables, and a third RDU memory resource for the segments of model data, such that the first RDU memory resource, the second RDU memory resource, and the third RDU memory resource may be selected from the local memory at the host, the HBM, and the DDR memory module pair.

In yet a further aspect, tangible second computer-readable media including instructions executable by a computer system for workload resource reservation in a reconfigurable dataflow architecture are disclosed. The instructions in the second computer-readable media may be executable to receive a first workload for execution on an RDU system, including receiving a first workload reservation specifying a first RDU resource included in the RDU system. According to the instructions in the second computer-readable media, the first RDU resource may be selected from an RDU tile including multiple pattern compute units (PCUs), a local memory at a host, a high-bandwidth memory (HBM), a dual data rate (DDR) memory module pair, or a peripheral port. The instructions in the second computer-readable media may be further executable to determine an access condition for the first RDU resource selected from shared accessibility, exclusive accessibility, or allowed substitution. The instructions in the second computer-readable media may be further executable to initiate execution of the first workload according to the first workload reservation and the access condition. According to the instructions in the second computer-readable media, the RDU system may include a local interconnect and may be configured to receive workloads for execution, including the first workload, from the host via a system interconnect coupled to the local interconnect.

In any of the disclosed embodiments of the first computer-readable media, the instructions in the second computer-readable media may be executable to, during execution of the first workload on the RDU system, receive a second workload for execution on the RDU system, including receiving a second workload reservation for the second workload specifying a second RDU resource, and, when the second RDU resource corresponds to the first RDU resource, determine, based on the access condition, whether the second workload can use the second RDU resource.

In any of the disclosed embodiments of the first computer-readable media, the instructions in the second computer-readable media may be executable to, when the access condition for the first RDU resource is shared accessibility, allow the second workload to share the second RDU resource with the first RDU resource; and initiate execution of the second workload according to the second workload reservation.

In any of the disclosed embodiments of the first computer-readable media, the instructions in the second computer-readable media may be executable to, when the access condition for the first RDU resource is exclusive accessibility, prevent the second workload from executing on the RDU system.

In any of the disclosed embodiments of the first computer-readable media, the instructions in the second computer-readable media may be executable to, when the access condition for the first RDU resource includes allowed substitution, determine a third RDU resource corresponding to the second RDU resource if the second RDU resource is unavailable, where the third RDU resource may be available for the second workload. The instructions in the second computer-readable media may be executable to substitute the third RDU resource for the second RDU resource in the second workload reservation, and initiate execution of the second workload according to the second workload reservation.

In any of the disclosed embodiments of the first computer-readable media, the first workload may include an executable file that generates bitfiles and argument tables, and may further include segments of model data that cumulatively describe an AI/ML application corresponding to the first workload. According to the instructions in the second computer-readable media, the first workload reservation may specify a first RDU memory resource for the bitfiles, a second RDU memory resource for the argument tables, and a third RDU memory resource for the segments of model data, such that the first RDU memory resource, the second RDU memory resource, and the third RDU memory resource are selected from the local memory at the host, the HBM, or the DDR memory module pair.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of a reconfigurable dataflow architecture, in one embodiment;

FIG. 2 is a block diagram of a high-performance computer (HPC) host, in one embodiment;

FIG. 3 is a block diagram of a computer system host, in one embodiment;

FIG. 4 is a depiction of a neural network model, in one embodiment;

FIG. 5 is a block diagram of a reconfigurable dataflow unit (RDU) system compilation, in one embodiment;

FIG. 6 is a block diagram of a reconfigurable dataflow runtime (RDRT) architecture, in one embodiment;

FIG. 7 is a block diagram of an RDU, in one embodiment;

FIG. 8 is a block diagram of an RDU die, in one embodiment;

FIG. 9 is a block diagram of an RDU tile, in one embodiment;

FIG. 10 is a block diagram of an RDU with further details, in one embodiment;

FIG. 11 is a block diagram of a local interconnect reservation, in one embodiment;

FIG. 12 is a block diagram of a memory reservation, in one embodiment;

FIG. 13 is a flow chart of a method for hardware resource reservation, in one embodiment; and

FIG. 14 is a flow chart of a method for workload resource reservation, in one embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted previously, typical CPU/GPU computer architectures may be constrained in performance and power consumption, especially for processing very large AI/ML workloads. To overcome certain limitations of typical CPU/GPU computer architectures, a reconfigurable dataflow architecture, as further described in detail herein, has been developed. In particular, the reconfigurable dataflow architecture can provide parallel processing using multiple compute units that are simpler than typical CPUs, and therefore, can operate faster and consume less power for comparable workloads. The reconfigurable dataflow architecture may be particularly suited for AI/ML workloads associated with respective layers or stages in a NN defining a computational model for execution, and may be dimensioned or scaled for very large AI/ML workloads corresponding to very large NNs.

The AI/ML workload executed by the reconfigurable dataflow architecture may include training procedures for developing and tuning a particular model, such as an LLM. The AI/ML workload executed by the reconfigurable dataflow architecture may also include usage of a trained model to generate desired output from input, also referred to as ‘inference’ using the trained model.

As noted, the reconfigurable dataflow architecture includes relatively simple modular components that are designed for parallelized workloads, such as AI/ML workloads. In the reconfigurable dataflow architecture, the coordination and control of workload processing is performed by a ‘host’ that is an external computer system that may operate using a conventional CPU and a corresponding operating system that supports sequential processing of instructions fed to the CPU, among other data processing capabilities. Accordingly, various management and configuration tasks for the reconfigurable dataflow architecture may be performed within the operating system executing at the host.

One management and configuration task performed for the reconfigurable dataflow architecture is the reservation of hardware resources allocated for execution of AI/ML workloads, such as an AI/ML application. The hardware resources may include compute resources, memory resources, and input/output (I/O) resources, as will be described further detail. In the reconfigurable dataflow architecture disclosed herein, execution of workload threads on the hardware of the reconfigurable dataflow architecture can be performed without direct involvement of the operating system on the host. The reconfigurable dataflow architecture first compiles executable instructions for RDU compute resources based on the AI/ML workload to be processed, such as by receiving an incoming request. The compilation and execution process also involves reserving and allocating the hardware resources on the target RDU system coupled to the host before the AI/ML workload is processed.

In a typical implementation of hardware resource reservation for subsequent allocation and execution of the AI/ML workload, an estimation of the hardware resources based on certain metrics associated with the specific AI/ML application can be generated, such as at compile time. Then, certain hardware elements can be reserved for allocation to the AI/ML application. Typically, however, the estimation of the hardware resources may be based on some assumed performance level for the AI/ML application, which may not be desirable. For example, the assumed performance level may be inaccurate for actual hardware capabilities. Furthermore, a certain degree of sharing of hardware resources among different concurrently executing AI/ML applications may be implicit in the typical estimation, which may also be undesirable.

Additionally, the estimation of hardware resources may be relatively inflexible, such as by applying a fixed relationship among compute resources, memory resources, and I/O resources that is generalized for all AI/ML workloads, but may not be entirely accurate for any one specific AI/ML workload. For example, the typical estimation of hardware resources may be applied in a modular manner that reserves entire RDUs as atomic units, along with all respective compute resources, memory resources, and I/O resources. The modular manner of reservation may be a poor match for any specific AI/ML workload, such as by not matching the actual consumption of the compute resources, memory resources, and I/O resources by the AI/ML workload. As a result, AI/ML workloads may execute inefficiently or with lower performance than is possible, or the actual computational loading of the hardware resources may remain less than optimal during operation, which may both be undesirable conditions, such as for economically optimized utilization of the RDU system over time. Also, when a ‘first-come first-serve’ approach is used with incoming AI/ML workloads in the modular manner, the number of AI/ML workloads that can be processed using the RDU system can be constrained due to the modular manner of resource reservation that can block out subsequent AI/ML workloads, even when hardware resource capacity may have been overall sufficient.

As disclosed herein, a reconfigurable dataflow architecture may include a plurality of RDUs that are coupled together using a local interconnect. Each of the RDUs may, in turn, include individual compute resources, memory resources, and I/O resources (i.e., hardware resources). The reconfigurable dataflow architecture disclosed herein may also include a host that communicates with the RDUs using a system interconnect coupled to the local interconnect. The reconfigurable dataflow architecture may include various embedded hardware components that are organized in a hierarchical modularized structure that includes various communication means that can enable sharing of hardware resources among different RDUs and within individual RDUs. The host can accordingly manage and configure the plurality of RDUs that form the RDU system, such as to allocate various hardware resources at various different RDUs. The usage and operation of the embedded hardware components in the reconfigurable dataflow architecture involves management and control of each individual instance of the components used. The management and control can include reservation of specific hardware resources for some or all AI/ML workloads to be processed, such that a fine granular allocation of the hardware resources can be achieved.

As will be described in further detail herein, for execution of AI/ML workloads, specific hardware resources may be reserved and then allocated, as disclosed in further detail herein. In some embodiments, the hardware resources may be reserved globally, such as for all AI/ML workloads on a given instance of the reconfigurable dataflow architecture. In particular embodiments, the hardware resources may be reserved for execution of a specific AI/ML workload, such that multiple AI/ML workloads concurrently executing on a given instance of the reconfigurable dataflow architecture may each individually reserve certain hardware resources among the available hardware resources.

Specifically, each RDU may include at least one RDU tile that provides the compute resources by executing compiled instructions sent by the host. Each RDU may further include at least one high-bandwidth memory (HBM) that is accessible to RDU tiles, along with dual data rate (DDR) memory that is also accessible to RDU tiles. The HBM memory and the DDR memory included in the RDU can provide the memory resources. The RDU may further include a number of peripheral ports that form the local interconnect, such as for coupling multiple RDUs together. The peripheral ports can accordingly provide the I/O resources. These hardware resources, as will be described in further detail, can be reserved for incoming AI/ML workloads, either globally for all or any workloads, or specifically for a given AI/ML workload. Furthermore, as will be described in further detail the resource reservation can be selected based on different conditional constraints, such as shared reservation, exclusive reservation, or substitutable reservation.

The hardware and workload resource reservation in the reconfigurable dataflow architecture disclosed herein can accordingly provide certain advantages that are desirable. The methods and systems for resource reservation disclosed herein, as noted, can contribute to more optimized or tunable performance for a given AI/ML application. Specifically, the AI/ML application can be executed using resource reservation, as disclosed herein, for a desired performance criteria, such as optimal performance, average performance, or slow performance. The RDU system may be operated at a generally higher level of performance availability, since an amount of unused or underutilized hardware components associated with an AI/ML application can be reduced. Furthermore, in the event that a certain hardware component that was reserved and allocated to the AI/ML application actually is or becomes degraded, or operates in a degraded manner, another hardware component that is know to operate in a desired manner can replace or substitute the degraded hardware component in a predictable manner.

The hardware and workload resource reservation in the reconfigurable dataflow architecture disclosed herein can provide particular advantages for very large AI/ML applications, such as when multiple parallel processing paths are used for runtime optimization, for example. The synchronization of the multiple parallel processing paths involved with an AI/ML workload or application can be important for reducing latency, such as at intermediate checkpoints that involve at least some synchronization. Therefore, when execution times among the individual processing paths with multiple parallel processing paths exhibit execution time variance outside of narrow tolerance limits, particularly at very high cycle rates, the overall execution time of the multiple parallel processing paths can deteriorate significantly, which is undesirable. However, when the hardware and workload resource reservation disclosed herein is used, each of the multiple parallel processing paths can be allocated defined or equivalent hardware resources that are precisely matched in performance capability. As a result, deterioration of overall execution time due to poor internal synchronization can be reduced or eliminated, which is desirable.

Similarly, when a given AI/ML application, or portion thereof, is indicated for a high degree of deterministic performance, the hardware and workload resource reservation disclosed herein can provide fine granular control of hardware resources to tune or optimally adjust runtime determinism. For example, certain AI/ML applications may involve the use of multiple NNs, such as in a combination of experts (CoE) implementation, that may involve certain combinations of performance, storage, and determinism constraints for which RDU hardware resources can be optimally reserved and allocated using the system and methods disclosed herein. As noted, when the hardware and workload resource reservation disclosed herein is applied to the RDU system, an overall improvement in both hardware utilization and workload performance may be attained, which further improves the overall economic and energy consumption performance associated with the reconfigurable dataflow architecture.

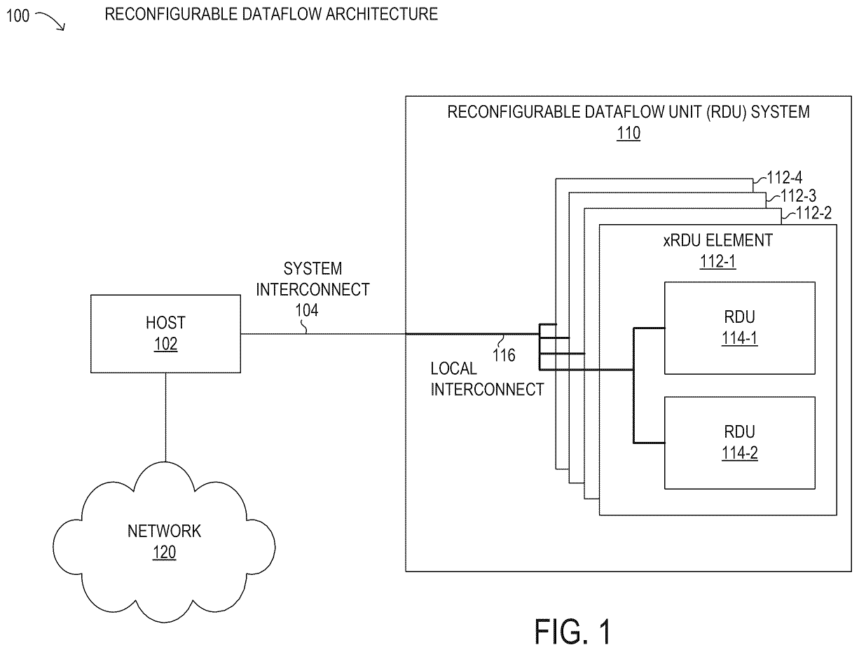

Referring now to the drawings, FIG. 1 depicts a block diagram of a reconfigurable dataflow architecture 100, or simply referred to as architecture 100, in one embodiment. FIG. 1 is a schematic illustration and is not necessarily drawn to scale or perspective. FIG. 1 is an exemplary implementation of reconfigurable dataflow architecture 100 for descriptive purposes. In some embodiments, reconfigurable dataflow architecture 100 may include or represent various different components and interconnections. As shown in FIG. 1, reconfigurable dataflow architecture 100 includes a host 102 coupled to an RDU system 110 by a system interconnect 104, while host 102 is also coupled to a network 120.

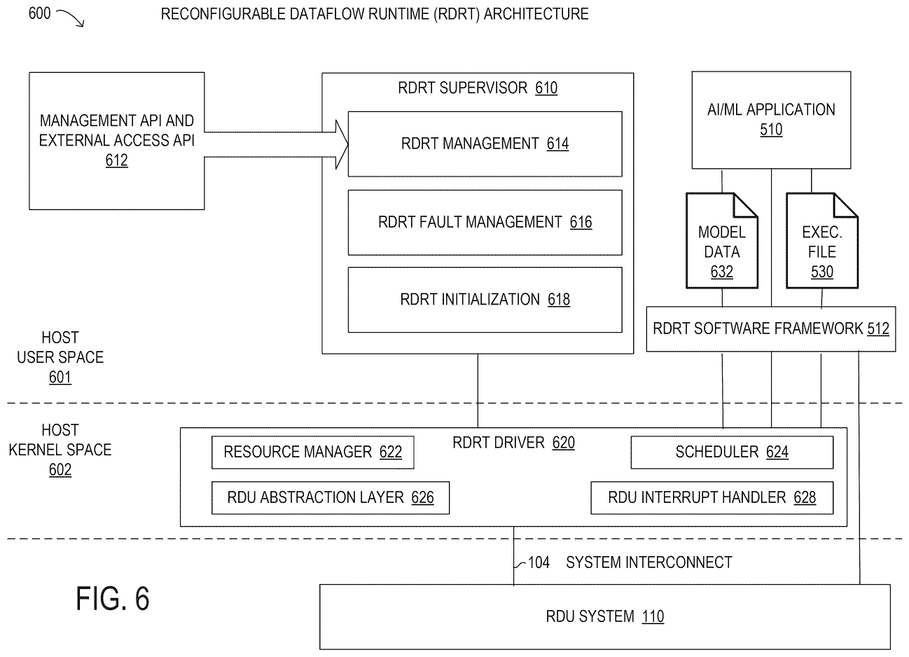

In general terms, reconfigurable dataflow architecture 100, which includes RDRT architecture 600 (see FIG. 6) is capable of managing graph execution and hardware resources of RDU system 110. In particular, reconfigurable dataflow architecture 100 can support data-flow AI/ML applications, such as ML training, low-latency inference, and extract-transform-load (ETL) enterprise processes. As will be described in further detail, reconfigurable dataflow architecture 100 is a modular architecture that is scalable for different types and sizes of workloads. For example, RDU system 110 can be scaled to use any number of RDUs 114, such as from 1 to 1024 or more in various embodiments. Various features and capabilities of reconfigurable dataflow architecture 100, whether in hardware or in software, have been designed and optimized for maximum or optimal compute performance and device memory utilization. In particular, reconfigurable dataflow architecture 100 can provide for efficient data exchange between host 102 and device memory included in RDU system 110, for example, by consuming low overhead of an operating system executing on host 102 during data exchange over system interconnect 104. Additionally, reconfigurable dataflow architecture 100 provides various tools and utilities for orchestration of model execution, including for execution management, debugging, and profiling, among others.

As shown in FIG. 1, network 120 can represent any of a variety of network systems, such a local area network (LAN), a wide area network (WAN) or combinations thereof. Network 120 can include or support wired and wireless network connections. In some embodiments, network 120 can include private network domains or public network domains, such as the Internet, or both public and private network domains. In particular embodiments, network 120 can be optional such that network 120 is not used, or access to network 120 by host 102 is blocked or prevented, in which case host 102 and RDU system 110 can operate privately without network access.

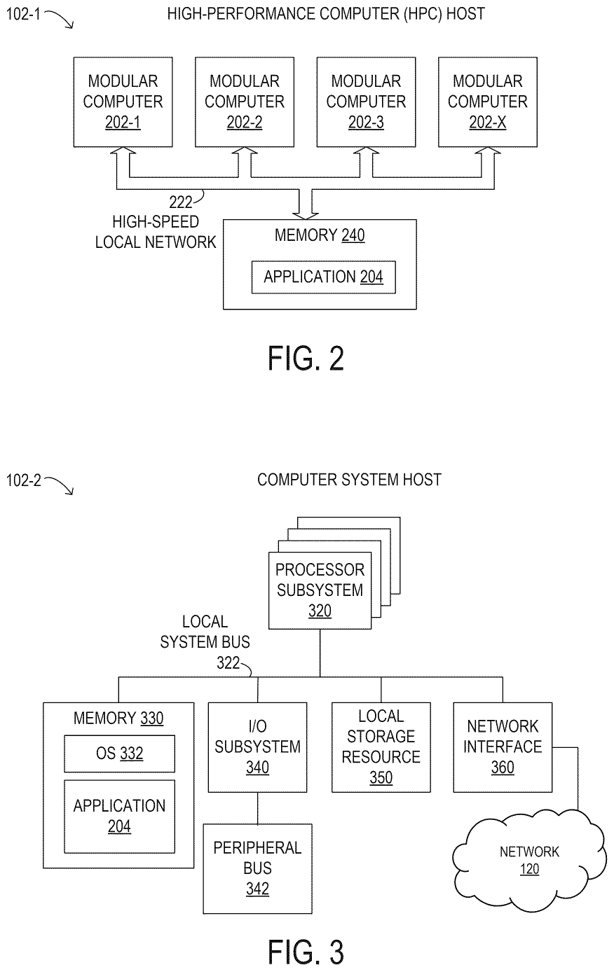

As shown in FIG. 1, host 102 can represent any of a variety of computer systems that can operate using a CPU and a corresponding operating system to enable the execution of software on host 102 using the CPU. In particular embodiments, host 102 can represent at least certain portions of a computer system host 102-2 (see FIG. 3) or a high-performance computer (HPC) host 102-1 (see FIG. 2), as will be discussed in further detail below. The operating system executing on host 102 may enable the execution of software to control RDU system 110, such as by providing a user space for general processing task execution and a kernel space for hardware I/O driver execution (see also FIG. 3), among other tasks or processes. In this manner, RDU system 110 can be exclusively controlled and operated by host 102, as will be described in further detail. Specifically, host 102 can be loaded with various software components and tools to enable development and execution of an application that can be executed using RDU system 110 for accelerated execution. The various software components and tools executing on host 102 can be developed for and integrated with RDU system 110. For example, the various software components and tools used at host 102 to control RDU system 110 can be developed and supplied by a manufacturer of RDU system 110 for the specific purpose of operating RDU system 110.

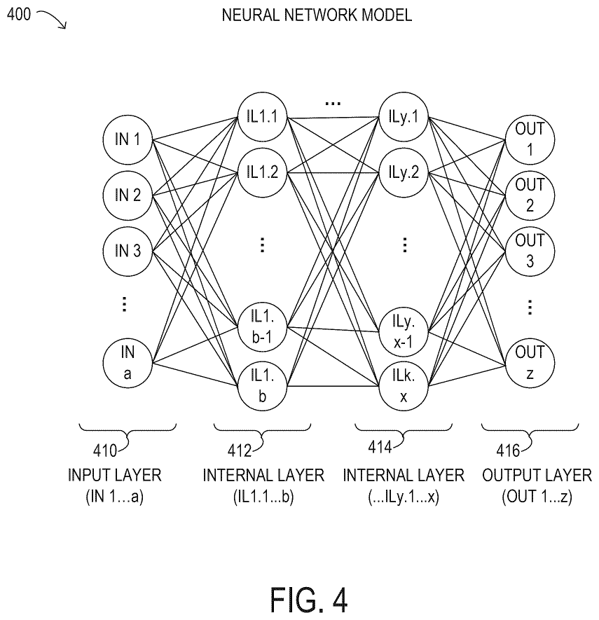

Accordingly, as shown in FIG. 1, RDU system 110 may be capable of operation using the various software components and tools installed at host 102 for controlling and managing RDU system 110. In particular, RDU system 110 may serve as an acceleration platform for executing workloads involving parallel data processing, and in particular, for AI/ML workloads. In various embodiments, AI/ML workloads can include training or inference of a NN model (see also FIG. 4), such as an LLM. Because RDU system 110 does not include various components and associated functionality typically included in a CPU, such as an instruction pipeline and clock, RDU system 110 may be specifically implemented for high-speed processing of AI/ML workloads. Furthermore, RDU system 110 may be capable of operating with lower power consumption for a comparable workload as a CPU or combined CPU/GPU systems, and in particular, for AI/ML workloads.

As depicted in FIG. 1, system interconnect 104 can be a primary or unitary connection for communication between host 102 and RDU system 110. In particular embodiments, system interconnect 104 can include a standard interface, such as a peripheral interconnect, an optical interconnect, or a network connection. For example, system interconnect 104 can represent a peripheral interconnect that is compatible with a peripheral component interconnect (PCI) bus standard. In some embodiments, system interconnect 104 can represent a network connection that is compatible with an Ethernet network standard. Furthermore, in particular embodiments, a total data processing throughput capacity of RDU system 110 can be determined based on a data throughput capacity of system interconnect 104 when system interconnect 104 is a singular connection to host 102. In other embodiments, system interconnect 104 can represent multiple parallel connections between host 102 and RDU system 110 that are bundled for increased throughput capacity. Accordingly, in different embodiments, host 102 can be configured to support various implementations of RDU system 110, such as different RDU systems 110 that are dimensioned with different numbers of components and having different overall data processing capacity.

As shown in FIG. 1, system interconnect 104 is communicatively coupled with local interconnect 116 that is used for various internal connections at RDU system 110. In some embodiments, system interconnect 104 and local interconnect 116 can include the same type of interface, such as a PCI bus standard, an optical bus standard, or an Ethernet network standard. In some embodiments, system interconnect 104 and local interconnect 116 can include different types of interfaces, such that a bridge or a bus multiplexer or similar interface conversion device is used between system interconnect 104 and local interconnect 116. Although depicted in FIG. 1 with a singular RDU system 110 having a certain number of internal components, system interconnect 104 may operate with (e.g., be coupled to) different numbers of RDU systems 110 or RDU systems having different numbers of internal components.

In FIG. 1, local interconnect 116 is shown branching to connect various internal components in RDU system 110. Specifically, RDU system 110 is shown including four (4) extensible RDU (xRDU) elements 112 that each include two (2) RDUs 114, of which xRDU element 112-1 having RDU 114-1 and RDU 114-2 are visible. In the exemplary embodiment of RDU system 110 in FIG. 1, xRDU elements 112-2, 112-3, and 112-4 can be identical to xRDU element 112-1. The branching of local interconnect 116 within RDU system 110 may be schematic to represent various bus topologies and distribution arrangements using corresponding additional equipment that is omitted from FIG. 1 for descriptive clarity. Furthermore, local interconnect 116 can further extend within RDU 114 to provide connections to various internal components of RDU 114, as described in further detail herein.

In particular embodiments, RDU system 110 may support so-called “on-board AI” in which an AI/ML model can be executed in the hardware included with RDU system 110 for acceleration of certain computational operations, such as linear algebra or matrix calculations. In particular, RDU system 110 can achieve acceleration factors of 1,000× or 10,000× or greater with respect to other types of processors. RDU system 110 can be specifically implemented to execute mathematical operations related to NN processing, such as linear algebra and tensor operations (including vector and matrix operations). In this manner, RDU system 110 can support large or very large AI/ML models that include NNs having 10⁹ or more neurons with multiple NN layers for complex logic. RDU system 110 can be used, thus, for efficient execution of trained AI/ML models for on-board AI applications.

The linear algebra calculations performed by RDU system 110 can include multiply-accumulate calculations, calculation of bias weights, or calculations of activation functions that may involve relatively simple and repetitive calculations performed at large scale, such as for on-board AI. As noted, in particular implementations, the linear algebra calculations performed by RDU system 110 may be structured as matrix operations and can be executed using simplified compute units configured for parallel execution to improve acceleration, as will be described in further detail. In particular implementations, a large amount of memory can be included with or be accessible to RDU system 110, such as to support larger on-board AI applications, as will be described further below. Furthermore, to enhance acceleration, RDU system 110 may be implemented to support lower precision numerical values, such as involving a smaller number of bits per numerical value, for NN calculations. In particular embodiments, RDU system 110 can support integer values rather than floating point values for improved acceleration.

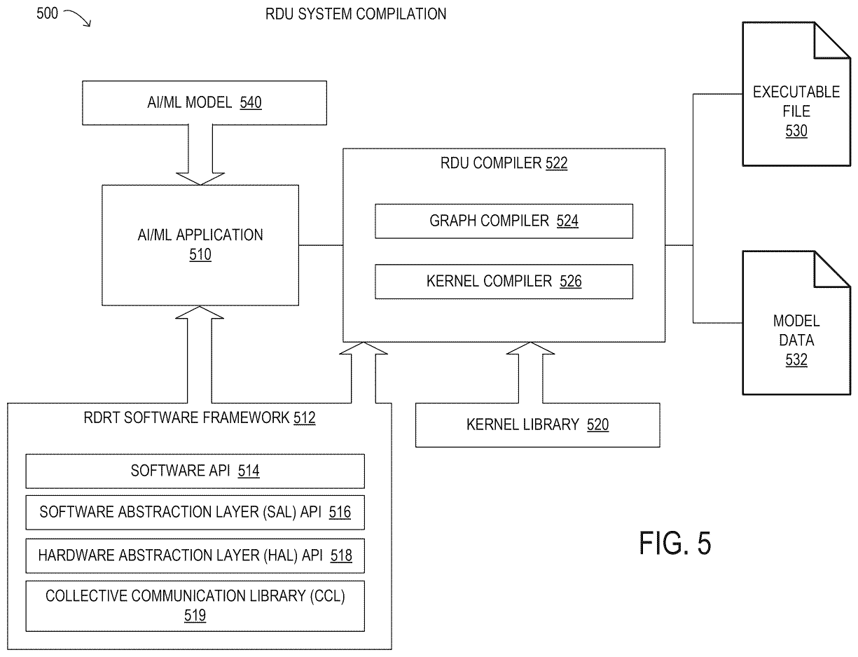

In operation of reconfigurable dataflow architecture 100, an application, such as an AI/ML application, can be prepared at host 102 for execution by RDU system 110. The functionality of the application along with data associated with the application can be configured at host 102 using software applications and tools installed on host 102 for operating RDU system 110. For example, the application can use application specific interface (API) function libraries for accessing hardware functionality within RDU system 110. The APIs may form part of a software development kit (SDK) that includes functions that can be called from the application to access a driver for RDU system 110 executing in kernel mode in an operating system running on host 102. For example, an AI/ML application can be compiled using an RDU compiler 522 (see also FIG. 5) on host 102 to generate an executable file 530 having binary code that is specific to RDU 114, as will be described in further detail. The executable file 530, along with model data 532 that describes a NN for the AI/ML application in some embodiments, can be sent for execution to at least one RDU 114 via local interconnect 116. The output from the NN can then be transferred back to the AI/ML application at host 102 via local interconnect 116. In this manner, RDU system 110 can be used for accelerated execution of the AI/ML application in reconfigurable dataflow architecture 100. The term “reconfigurable” can be indicative of the ability to generate (e.g., compile) executable file 530 that configures hardware in RDU system 110 for executing a particular application (rather than compiling code for execution by a CPU), while the term “dataflow” can be indicative of a parallelized workload, such as the AI/ML application based on the NN, that is driven by input data to generate output data (rather than by a clocked instruction pipeline as in a CPU).

FIG. 2 illustrates a block diagram depiction of a high-performance computer (HPC) host 102-1. In some embodiments, host 102 (see FIG. 1) may be implemented using HPC host 102-1 shown including multiple modular computers 202-1, 202-2, 202-3, 202-4. Although four modular computers 202-1, 202-2, 202-3, 202-4 are shown in FIG. 2 for descriptive purposes, it is noted that any number of modular computers 202 may be used. In particular embodiments, a large number of modular computers 202 may be aggregated in HPC host 200 to provide greater computing capacity. Accordingly workloads, may be executed in a distributed manner in HPC host 200, by implementing multi-node application execution, such that multiple modular computers 202-1, 202-2, 202-3, 202-4 share processing of work tasks that may be performed in a parallel or simultaneous manner.

As shown in FIG. 2, HPC host 200 can be described in general terms as a collection of modular computers 202-1, 202-2, 202-3, 202-4 or any number of computers that respectively include a local processor and local memory and are interconnected by high-speed local network 222, which may be a dedicated high-bandwidth, low-latency network. HPC host 200 can accordingly aggregate and combine the computational power of multiple modular computers 202-1, 202-2, 202-3, 202-4, or any number of modular computers, to perform large-scale work tasks. HPC host 200 can flexibly scale HPC resources that can be matched to desired work tasks. HPC host 200 can also provide configuration for work task parallelization, data distribution, parallel execution, host monitoring and control, as well as supporting parallelized computations having combined output. Various software applications can execute on HPC host 200 in a local or distributed manner, such as on a single modular computer 202-1 or on multiple modular computers with the addition of modular computers 202-2, 202-3, 202-4, or another number of modular computers.

As shown in FIG. 2, HPC host 200 is shown including a memory 240, which may represent one or more memory devices that are compatible with high-speed local network 222. High-speed local network 222 may be a dedicated local bus such as including InfiniBand, 40 Gb Ethernet, or PCIe. Accordingly, memory 240 can provide access to storage resources using low latency high-speed local network 222 to support work tasks handled by HPC host 200. It is further noted that HPC host 200 may include a dedicated network interface that can provide network connectivity by using modular computers 202-1, 202-2, 202-3, 202-4, or another number of modular computers.

In particular embodiments, modular computer 202 in HPC host 102-1 can be an instance of computer system host 102-2 (see FIG. 3) that includes a peripheral bus 342 for use with system interconnect 104 (see FIG. 1). In some embodiments, high-speed local network 222 can be coupled for use with system interconnect 104. In particular, memory 240 is shown storing an application 204 that can be executed, at least in part, using RDU system 110, as described herein with respect to architecture 100.

FIG. 3 illustrates a block diagram depiction of a computer system host 102-2, in accordance with one or more embodiments of this disclosure. Embodiments described herein may be implemented using a computer system, such as computer system host 102-2, in an individual manner or in a cluster of multiple computer systems. Accordingly, computer system host 102-2 may represent any of a variety of computing devices, such as, but not limited to personal computers, desktop computers, laptops, tablets, mobile devices, smart phones, cloud servers, blade computers, microcomputers, embedded devices, or modular computers, among others.

As shown in FIG. 3, computer system host 102-2 includes a processor subsystem 320, a local system bus 322 for interconnecting various local elements, a memory 330, an operating system (OS) 332, an input/output (I/O) subsystem 340, a local storage resource 350, a network interface 360, and network 120.

As shown in FIG. 3, processor subsystem 320 may include an integrated circuit (IC), such as in the form of a semiconductor device that is formed using at least one substrate, such as silicon. Processor subsystem 320 may accordingly be used for interpreting and executing program instructions and processing data that is stored either locally or remotely or both. Processor subsystem 320 may include a central processing unit (CPU) that uses an instruction set architecture to execute instructions, such as, but not limited to an advanced reduced instruction set computer (RISC) machine (ARM) architecture or an x86 architecture.

As shown in FIG. 3, a local system bus 322 may represent a variety of suitable types of bus structures, such as but not limited to a memory bus, a data bus, an address bus, a control bus, or a peripheral bus, among various other examples.

As shown in FIG. 3, memory 330 may include a system, device, or apparatus operable to retain and retrieve processor-executable instructions or data or both, such as for a period of time. Memory 330 may include volatile memory such as RAM, including video RAM (VRAM), static RAM (SRAM), or dynamic RAM (DRAM), cache memory, and non-volatile memory. Memory 330 may include or represent a computer-readable non-transitory medium that includes, but is not limited to portable or non-portable storage devices, optical storage devices, magnetic storage devices, or various other storage media. The processor-executable instructions may include a procedure, a function, a subprogram, a program, a routine, a subroutine, a module, a software package, a data object, a data structure, or a program statement, or various combinations thereof.

As shown in FIG. 3, an OS 332 is stored in memory 330. OS 332 may represent an execution environment for various program code executing on computer system host 102-2. OS 332 may be any of a variety of standard or customized operating systems, such as but not limited to a Microsoft Windows® operating systems, a UNIX or a UNIX-based operating system, a mobile device operating system, an Apple® MacOS or iOS operating system, an embedded operating system, or a hypervisor for executing multiple virtual machines on common hardware, among others. OS 332 can be an operating system that supports shared memory, distributed memory, virtual memory, contiguous or non-contiguous memory allocation, among other memory arrangements. Also shown included with memory 330 is application 204 described above with respect to FIG. 2 and that can represent an AI/ML application for execution on RDU system 110, as described herein.

As shown in FIG. 3, in computer system host 102-2, I/O subsystem 340 may include a system, device, or apparatus generally operable to receive/transmit data to or from or internally within computer system host 102-2. In different embodiments, I/O subsystem 340 may be used to support various peripheral devices or interfaces. I/O subsystem 340 may represent a variety of communication interfaces such as, but not limited to, graphics interfaces, video interfaces, user input interfaces, and peripheral interfaces. I/O subsystem 340 may support various output or display devices, such as but not limited to a screen, a monitor, a general display device, a liquid crystal display (LCD), a plasma display, a touchscreen, a projector, a printer, an external storage device. In particular, I/O subsystem 340 is shown providing peripheral bus 342 that can support system interconnect 104, as described above with respect to FIG. 1.

As shown in FIG. 3, local storage resource 350 may comprise non-volatile or persistent computer-readable media such as a hard disk drive, CD-ROM, and other type of rotating storage media, flash memory, electrically erasable programmable read-only memory (EEPROM), or another type of storage media, and may be generally operable to store instructions and data and to permit access to stored instructions and data on demand. Local storage resource 350 may include a storage appliance or a storage subsystem having one or more arrays of storage devices such as for supporting redundancy, mirroring, or real-time data error correction and restoration.

As shown in FIG. 3, network interface 360 may facilitate connecting computer system host 102-2 to network 120. Network 120 may represent various configurations, such as but not limited to a local area network (LAN), a wide area network (WAN) such as the Internet, or a mobile network, such as a wireless network. Network interface 360 may accordingly include or support wireless networks or wired networks. The wired network media supported by network interface 360 (or included in I/O subsystem 340) may include analog media, universal serial bus (USB), Apple® Lightning®, Ethernet, peripheral connect interface express (PCIe), DisplayPort (DP), Thunderbolt, fiber optics, a proprietary wired media, or an ad-hoc network media, among others. The wireless network media supported by network interface 360 may include or support visible light communication (VLC), worldwide interoperability for microwave access (WiMAX), a Bluetooth® wireless signal transfer, an IBEACON® wireless signal transfer, an radio-frequency identification (RFID) wireless signal transfer, near-field communications (NFC) wireless signal transfer, dedicated short range communication (DSRC) wireless signal transfer, 802.11 WiFi wireless signal transfer, wireless local area network (WLAN) signal transfer, infrared (IR) communication wireless signal transfer, global navigation satellite system (GNSS), global system for mobile communication (GSM), such as 3G/4G/5G/LTE cellular data network wireless signal transfer, radio wave signal transfer, microwave signal transfer, infrared signal transfer, visible light signal transfer, ultraviolet light signal transfer, or more generally, various kinds of wireless signal transfer along using radiation in a wavelength range of the electromagnetic spectrum.

FIG. 4 depicts an NN model 400 in one embodiment. NN model 400 is depicted as a neural network architecture having an input layer 410, internal layers 412, 414, and an output layer 416. In particular embodiments, implementation and use of NN model 400 may be performed using RDU system 110, as described herein. For example, executable file 530 can be compiled to configure and operate RDU system 110 to implement NN model 400 in various embodiments. In some embodiments, model data 532 can also be sent to RDU system 110 for this purpose (see FIG. 5).

In the mathematical processing of NN model 400 of FIG. 4, the processing at each layer can be represented by an activation function that can be generalized by Equation 1.

$$y = {\sum }_{i} ( {w}_{i} {x}_{i} ) + b \qquad Equation 1$$

In Equation 1, y is an output value, i represents an index variable or dimension for each layer input, such as a, b. x, and z in FIG. 4; xi represents the input value at each neuron, such as from another neuron; wᵢ represents a weighting coefficient applied at each neuron; and b represents a constant for each neuron. The output of each neuron can be represented by output value y of Equation 1, among other parameters in particular embodiments.

The process of activation of each internal layer as described above and illustrated in FIG. 4 is generally known as feedforward activation, which characterizes the typical use of a neural network to receive input and generate output. Feedforward may occur over multiple timesteps and may involve the use of externally generated data that are referred to as “tokens”, internally generated data, or both. The use of feedforward activation within NN model 400 to generate output (separate from feedback, backpropagation, and other types of training) is also known as “inference”.

It is noted that although NN model 400 is depicted with a certain set of nodes or artificial neurons (referred to herein as simply “neurons”) in FIG. 4, the dimensionality and structure of NN model 400 can be adapted for various specific types of data and applications. For example, as shown, NN model 400 can be expanded to a number of input neurons, w number of input layers each having b through x number of neurons respectively, and z number of output neurons. It is noted that a, b through x, w, and z can each have different dimensions, such as 10³, 10⁶, 10⁹, 10¹², among other values in various embodiments. Furthermore, although a single network is shown with NN model 400 in FIG. 4, it is noted that in different implementations, NN model 400 can be structured to incorporate different numbers of networks, such as by implementing a branched or otherwise structured topology.

In order to implement NN model 400 for a given useful application, a training process can be employed to determine respective weighting coefficients applied at each neuron, such as using Equation 1 or another activation function. For example, weighting coefficients associated with neurons in NN model 400 can be represented as a 2-D tensor (e.g., a matrix) that are included in model data 532 as explained in further detail below.

In the field of NNs and ML, optimization algorithms can be useful for training models by minimizing the error between the predicted output and target values. One known class of optimization algorithms are gradient descent algorithms. Gradient descent can be an iterative optimization algorithm used to minimize a “cost function” (also referred to as a “loss function”), which quantifies an error or a difference between an ML model's prediction and a target value (e.g., a known reference value). The gradient descent can operate by adjusting the parameters of the NN to reduce the error over multiple iterations.

To identify a direction and a magnitude by which model parameters are to be updated, gradients represented by partial derivative of a given model parameter with respect to the cost function, can be computed. For typical feedforward NNs, as shown in NN model 400, the computation of the gradients can be done using so called “backpropagation”, which involves a reverse application of a chain rule to propagate the gradient of the loss function backwards through the NN. In particular embodiments, backpropagation may be used to iteratively train NN model 400, such as by using RDU system 110. For example, the calculated output of NN model 400 may be represented by output data while the reference output may be represented by validation data. The backpropagation method may begin with output layer 416 and then iterate in a reverse manner over internal layer 414, then internal layer 412, to finally arrive at input layer 410.

Because most useful NN models have large numbers of inputs and outputs, backpropagation can be resource-intensive. While the calculation of the cost function itself can be relatively simple and fast, calculation of the gradients with respect to the cost function is generally more resource intensive. For some NN models, the runtime of each backpropagation for training may be greater than the feedforward activation for inference. Accordingly, reconfigurable data flow architecture 100 shown in FIG. 1, and as described herein, can provide acceleration of computations, such as in backpropagation for training or feedforward activation for training, which is desirable.

FIG. 5 is a block diagram of an RDU system compilation 500, in one embodiment. FIG. 5 is a schematic illustration of a process describing RDU system compilation 500, in one exemplary embodiment. It is noted that various other elements or different arrangements of RDU system compilation 500 can be used or performed in different embodiments.

As shown in FIG. 5, RDU system compilation 500 includes an AI/ML application 510 and an RDU compiler 522 that can represent different software applications capable of execution on host 102. In particular, AI/ML application 510 and RDU compiler 522 can be executed in a host user space 601 within an operating system executing on host 102, such as OS 332 (see also FIGS. 3 and 6). AI/ML application 510 can represent at least some software functionality defined by a user of reconfigurable data flow architecture 100 for execution using RDU system 110. For example, AI/ML application may be developed or programmed by the user (or on behalf of the user) using various tools and software routines, as noted above. Specifically, API function libraries for accessing hardware functionality within RDU system 110 can be provided as an RDRT software framework 512. The functions in API function libraries of RDRT software framework 512 can be integrated into the code of AI/ML application 510 or RDU compiler 522, as shown in FIG. 5, to provide runtime access to commensurate functionality performed by an RDRT driver 620 executing in a host kernel space 602 (see FIG. 6) within the operating system executing on host 102.

In FIGS. 5 and 6, various external function libraries and data structures are shown with arrowed boxes indicating contribution of code elements directed to a software application. For example, the code elements, such as API function libraries, can be integrated into the software element during development or programming, and then can be compiled into an executable form of the application. In some cases, code elements can be added or integrated as options or features in an application level tool.

In FIG. 5, an AI/ML model 540 and RDRT software framework 512 are shown contributing to the source code of AI/ML application 510 in this manner. Specifically, AI/ML model 540 may represent a NN-based model, such as an LLM, that the user of reconfigurable dataflow architecture 100 seeks to implement and run using RDU system 110, and for which purpose AI/ML application 510 is developed, including specific support for hardware features of RDU system 110. Accordingly, AI/ML model 540 can be provided by the user, or on behalf of the user, in various embodiments. It is noted that AI/ML model 540 may represent a local or remote source of data describing or defining the NN-based model, such as NN model 400 (see FIG. 4), which may be defined using a 2-D tensor of weighting coefficients (wᵢ), for example, among other values.

As shown in FIG. 5, RDRT software framework 512 comprises various API function libraries, including a software API 514, a software abstraction layer (SAL) API 516, a hardware abstraction layer (HAL) API 518, and a collective communication library (CCL) 519. The API function libraries (514, 516, 518, 519) included with RDRT software framework 512 can define a so-called “application stack” using the system-level function libraries that allow the user to run AI/ML model 540 on RDU system 110. The application stack can accordingly be implemented for a specific user application as AI/ML application 510. In particular, CCL 519 can be used for orchestration and coordination of the data-parallel execution of AI/ML model 540 using RDU system 110. In particular, CCL 519 can support non-blocking and standard-mode blocking of P2P communications among RDUs 114, persistent communication requests, as well as allowing AI/ML application 510 to directly access device memory on RDU 114, for example, to eliminate a redundant copy of memory contents at host 102. In particular, CCL 519 may provide a transport layer that supports different interfaces for system interconnect 104, such as to accelerate memory transfers between different RDUs 114, such as by supporting remote direct memory access (RDMA). For example, CCL 519 may support or select among various available interfaces, such as PCIe, RDMA over Converged Ethernet (ROCE), or InfiniBand, among others.

Also in RDU system compilation 500 is RDU compiler 522 that represents another software tool executable at host 102 to generate executable file 530 and model data 532 that are compiled into a format that is specific for RDU system 110. In particular, executable file 530 and model data 532 can be used to execute AI/ML model 540 on RDU system 110, as also defined or specified by AI/ML application 510. In some embodiments, such as when using RDU system 110 to implement externally developed AI/ML models, external model data instead of model data 532 can be used. In particular embodiments, RDU compiler 522 can itself be comprised of functional libraries and routines that are invoked using RDRT software framework 512 as a development environment for implementing AI/ML model 540. In various embodiments, RDRT software framework 512 can also be used to develop AI/ML application 510. Accordingly, RDRT software framework 512 can perform model graph tracing, invoking RDU compiler 522, and orchestrating execution of AI/ML model 540. A selection of RDRT software framework 512 can depend on a hardware or operating system environment used for host 102. Some examples of software platforms that can be used for RDRT software framework 512 include PyTorch or TensorFlow, among others.

As shown in FIG. 5, a kernel library 520 may include a set of operator kernels that supports both a graph compiler 524 a kernel compiler 526 that comprise RDU compiler 522. In particular, kernel library 520 can be specifically optimized for RDU system 110. Graph compiler 524 may be responsible for model-level graph transformation and various optimizations in this regard. For example, graph compiler 524 may transform or convert a model graph of AI/ML model 540 into compiled RDU kernel graphs and execution schedules included with model data 532 for execution on RDU system 110. Similarly, kernel compiler 526 may transform the RDU kernel graphs into executable file 530 that is specific for RDU system 110 as the execution target.

FIG. 6 is a block diagram of an RDRT architecture 600, in one embodiment. FIG. 6 is a schematic illustration of a post-compilation runtime process for executing AI/ML model 540, represented in FIG. 6 by executable file 530 and a model data 632, on RDU system 110 in one exemplary embodiment. It is noted that various other elements or different arrangements of RDRT architecture 600 can be used in different embodiments.

In FIG. 6, RDRT architecture 600 comprises an RDRT supervisor 610, AI/ML application 510, and RDRT software framework 512 that are software applications or modules executing in host user space 601 on host 102. RDRT architecture 600 also comprises an RDRT driver 620 executing as a kernel service in host kernel space 602 on host 102. RDRT driver 620 is further shown as a logical endpoint of system interconnect 104 to RDU system 110. RDRT driver 620 may control and manage system interconnect 104, including managing a host memory space associated with system interconnect 104 as well as direct memory access (DMA) transfers via system interconnect 104. In various embodiments, RDRT software framework 512 may directly communicate with RDU system 110 such as for various hardware and software configuration purposes. Accordingly, as given in RDRT architecture 600, RDRT driver 620 and RDRT software framework 512 may perform or enable various tasks associated with configuring and orchestrating execution of executable file 530 and model data 632 on RDU system 110.

In some embodiments, at least certain portions of RDRT driver 620 (or an equivalent module) may be executed in host user space 601, instead of host kernel space 602. For example, a kernel driver for system interconnect 104 may be used, such that other functionality shown with RDRT driver 620 can operate in host user space 601.

As shown in FIG. 6, model data 632 can represent model data 532 generated by RDU compiler 522, or external model data from an external source in some embodiments. For example, RDRT driver 620 may provide a graph finite state machine (FSM) and handle data transfer to RDU system 110. Additionally, RDRT driver 620 may access control/status registers (CSR) on RDU system 110 to interact with, monitor, and control various actions, such as by reading or writing a particular CSR for a particular purpose.

As shown in FIG. 6, RDRT driver 620 includes various modules including a resource manager 622, a scheduler 624, an RDU abstraction layer 626, and an RDU interrupt handler 628. Resource manager 622 may coordinate and allocate hardware resources on RDU system 110 with respect to workloads for a given AI/ML application 510. Scheduler 624 may represent software-based scheduling of processing tasks on RDU system 110 (in contrast to local hardware scheduling in RDU system 110).

In FIG. 6, RDRT supervisor 610 can be a user operated application that handles fault management and initialization during runtime, among other tasks, on RDU system 110. Accordingly, RDRT supervisor 610 is shown including RDRT management 614 that can integrate functions and features from management API and external access API 612 for the user, among other monitoring and control functions for RDU system 110. RDRT management 614 can accordingly be used to programmatically request information about RDU status, manage RDUs, and retrieve information about host 102. RDRT fault management 616 includes a framework that supports reporting, diagnosing, and analyzing system error and fault events associated with RDU system 110, including reporting, logging, and clearing faults, among other actions. RDRT initialization 618 includes functionality for initializing hardware components in RDU system 110 prior to runtime, such as upon startup, in order to place the hardware components in a desired operational state or condition. RDU interrupt handler 628 may include subroutines that can be triggered in response to one or more interrupts that are generated by RDU 114. For example, RDU interrupt handler 628 may report interrupts to RDRT supervisor 610 for further handling and processing.

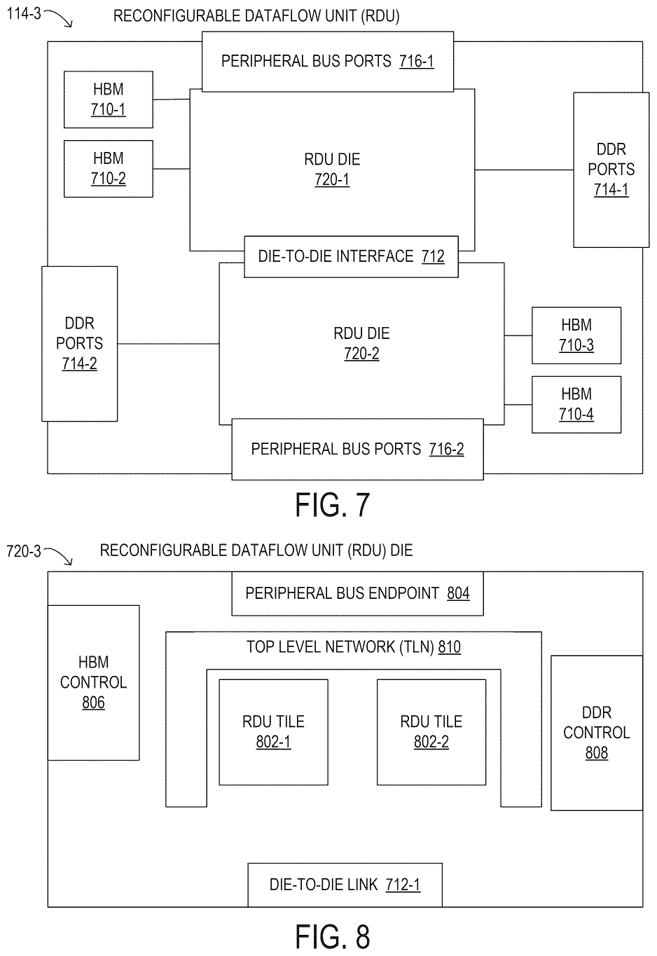

In FIGS. 7, 8, and 9, various internal components of RDU 114 included with xRDU element 112 are shown (see FIG. 1). FIGS. 7, 8, and 9 are schematic illustrations and are not necessarily drawn to scale or perspective. It is also noted that in FIGS. 7, 8, and 9, various components are depicted and described below, while various other details, such as connection traces, power routing elements, and various circuit details are omitted for descriptive clarity. In particular, various communication links that provide communicative and signaling functionality among depicted components in FIGS. 7, 8, and 9 are omitted for descriptive clarity. In some embodiments, different components can be included with RDU 114 than depicted in the exemplary embodiments of FIGS. 7, 8, and 9 presented for descriptive purposes.

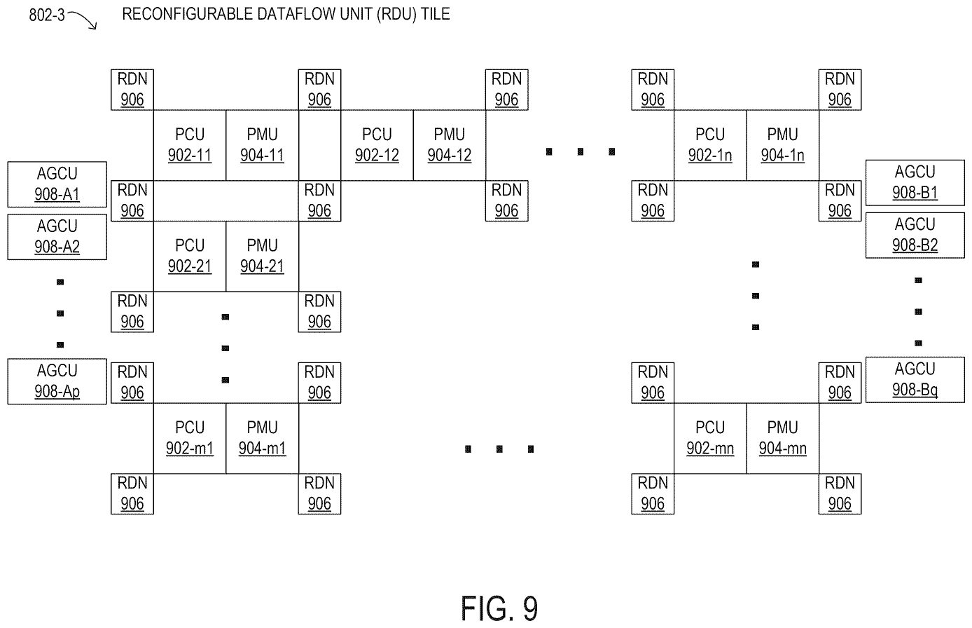

As noted above, in the exemplary embodiment of reconfigurable dataflow architecture 100 in FIG. 1, xRDU element 112-1 is depicted as being populated with two (2) RDUs 114-1, 114-2, each of which being coupled to local interconnect 116. It is noted that the arrangement depicted in FIG. 1 is an example for descriptive purposes and that different numbers of RDUs 114 may be integrated into xRDU element 112 in different embodiments. FIG. 7 depicts an exemplary embodiment of RDU 114-3; FIG. 8 depicts an exemplary embodiment of an RDU die 720-3; FIG. 9 depicts an exemplary embodiment of an RDU tile 802-3.

FIG. 7 is a block diagram of RDU 114-3, in one embodiment. In particular embodiments, RDU 114-3 can be packaged as a dual die socket using chip-on-wafer-on-substrate (CoWoS) multi-chip packaging. As shown, RDU 114-3 includes two RDU die 720-1, 720-2 that are coupled together with a die-to-die (D2D) interface 712. RDU 114-3 also includes two banks of peripheral bus ports 716 that provide various internal and external connections for each RDU die 720, respectively. Specifically, peripheral bus port 716-1 is accessible to RDU die 720-1, while peripheral bus port 716-2 is accessible to RDU die 720-2. In some embodiments, peripheral bus port 716 can provide a host interface via local interconnect 116, as well as multiple internal peer-to-peer (P2P) links to other RDUs 114 in RDU system 110. The host interface at peripheral bus port 716 can be coupled to, or form a portion of local interconnect 116 (see FIG. 1) and further be coupled to host 102 via system interconnect 104. In this manner, system interconnect 104 and local interconnect 116 can provide direct memory access (DMA) over the host interface between host memory (such as memory 330, see FIG. 3) and HBM 710 or DDR memory (not shown), as well as direct communication between host 102 and RDU tile 802. Additionally, each RDU die 720 is coupled to two (2) high bandwidth memories (HBM) 710 and at least one double data rate (DDR) memory port 714 that supports external DDR memory (not shown). Specifically, RDU die 720-1 is coupled to HBM 710-1 and HBM 710-2, along with DDR memory ports 714-1, while RDU die 720-2 is coupled to HBM 710-3 and HBM 710-4, along with DDR memory ports 714-2. As will be described in further detail, RDU die 720 includes multiple pattern compute units (PCU) 902 and pattern memory units (PMU) 904 (see FIG. 9) for executing parallelized workloads.

Accordingly, a three tier memory architecture implemented in RDU 114-3 includes PMU 904 (not visible in FIG. 7, see FIG. 9), HBM 710, and DDR memory ports 714, which is desirable. In particular embodiments, HBM 710 can have a capacity of 64 GB with a throughput bandwidth of at least 1.8 TB/s, while DDR memory port 714 can support a capacity of 1.5 TB with a throughput bandwidth of at least 200 GB/s. In particular embodiments, HBM 710 and DDR memory port 714 can be managed by software, such as by using RDRT driver 620 at host 102.

FIG. 8 is a block diagram of RDU die 720-3, in one embodiment. As shown, RDU die 720-3 includes a peripheral bus endpoint 804 that can represent an endpoint of peripheral bus ports 716. RDU die 720-3 also includes D2D interface 712-1 that represents one endpoint of D2D interface 712. D2D interface 712 can enable components in RDU tile 802 to stream data between two RDU die 720, such as between RDU die 720-1 and 720-2 in FIG. 7, in a direct manner that may be independent of external memory, such as HBM 710 and DDR memory (not shown). RDU die 720-3 is further shown including an HBM control 806 for interfacing to HBM 710, as well as DDR controller 808 for interfacing with DDR memory ports 714 that support external DDR memory (not shown).

In FIG. 8, RDU die 720-3 is also shown including two (2) RDU tiles 802 that represent dataflow cores performing the core computing operations in RDU system 110, and further include an array of PCUs 902 and PMUs 904, described in further detail below with respect to FIG. 9. Specifically, RDU tile 802-1 and RDU tile 802-2 are provided with a top-level network (TLN) 810 that interfaces with RDU tiles 802 and handle parallelized data throughput to and from RDU tiles 802, such as between RDU tile 802 and host 102, HBM 710, DDR memory ports 714, as well as P2P links to other RDUs 114 via peripheral bus ports 716.

FIG. 9 is a block diagram of RDU tile 802-3, in one embodiment. In particular embodiments, as shown in FIG. 8, RDU die 720 includes two (2) RDU tiles 802. However, in various implementations, different number of RDU tiles 802 can be included in RDU die 720. In FIG. 9, RDU tile 802-3 may represent a coarse-grained reconfigurable array (CGRA) of dataflow cores that each include a pattern compute unit (PCU) 902 coupled with a pattern memory unit (PMU) 904. In addition, RDU tile 802-3 includes multiple address generation and coalescing units (AGCUs) 908 that may be connected together in a two-dimensional (2D) mesh interconnect, referred to as a reconfigurable dataflow network (RDN) 906.

Specifically, as shown in FIG. 9, the array of dataflow cores is shown comprising the 2D mesh array in RDU tile 802-3 is comprised of array elements having one PCU 902 coupled with one PMU 904. In FIG. 9, RDU tile 802-3 is shown having a first array element PCU 902-11/PMU 904-11 at a top left corner. A first row of array elements in RDU tile 802-3 includes PCU 902-12/PMU 904-12 in a second column, and further array elements, up to PCU 903-1n/PMU 904-1n for n number of columns. A first column of array elements in RDU tile 802-3 includes PCU 902-21/PMU 904-21 in a second row, and further array elements, up to PCU 903-m1/PMU 904-m1 for m number of rows. A last array element in RDU tile 802-3 PCU 902-mn/PMU 904-mn is at a bottom right corner in FIG. 9. Also in RDU 802-3, RDN 906 is depicted as a plurality of switching elements at each corner of each individual array element that together represent the 2D mesh interconnect, where each RDN 906 switching element can connect to adjacent elements orthogonally and diagonally. Furthermore, the 2D mesh interconnect collectively represented by RDN 906 in FIG. 9 can connect externally to RDU tile 802-3 with TLN 810, as noted above.

In FIG. 9, AGCUs 908 are shown in two columns at the left and at the right. A first column is shown including AGCU 908-A1, AGCU 908-A2, up to AGCU 908-Ap for p number of AGCUs in the first column. A second column is shown including AGCU 908-B1, AGCU 908-B2, up to AGCU 908-Bq for q number of AGCUs in the second column. In particular embodiments, p and q can be different integers, or can be equal in some cases.

In operation of RDU tile 802-3, PCUs 902 can provide systolic and streaming compute capabilities. A datapath of PCUs 902 can include a header, a body, and a tail. The header of PCUs 902 can consume incoming dataflows and can drive the body. The body of PCUs 902 can be configurable as an output stationary systolic array or as a pipelined single-instruction-multiple-data (SIMD) core with multiple stages of vector compute. The tail of PCUs 902 can perform special element-wise functions and can populate a number of output first-in-first-out (FIFO) buffers included with PCU 902. The PCUs 902 datapath can accordingly perform efficient execution of general matrix multiply (GEMM) or similar operations, element-wise operations, or reductions.

In operation, PCUs 902 can function as either a 2D systolic array or as a SIMD core. The 2D systolic array can accelerate matrix multiplications, such as GEMM. Inputs to the 2D systolic array may be streamed left-to-right and top-to-bottom (as shown in FIG. 9) through a broadcast buffer. Accumulated results can be drained left-to-right to output FIFOs through the tail of PCUs 902. Matrix multiplication can be parallelized further across multiple PCUs 902. As a SIMD core, PCUs 902 can execute a parallel multidimensional tensor operation in a pipelined manner. Each SIMD stage can support common arithmetic, logical, and bit-wise operations in various numerical representations and precision, such as FP32, BF16, and INT32 formats. In addition, PCUs 902 can be optionally configured to implement a cross-lane reduction network. Lane-wise reductions can also be supported by PCUs 902 in a typical SIMD manner. PCUs 902 can include certain counters that track loop iterations and generate control events, such as when a counter reaches a programmed maximum value, indicating that a loop has completed execution, for example.

The tail of PCUs 902 can support transcendental functions, random number generation, stochastic rounding, and format conversions. An operation at the tail can be fused and pipelined with a compute operation in the body of PCUs 902. An operation can be parallelized across multiple PCUs 902 in a data parallel, tensor parallel, or pipeline parallel fashion. Data parallelism may be achieved by partitioning inputs and outputs to RDU tile 802 to create multiple independent data streams that can be processed by different PCUs 902. Tensor parallelism may be achieved by forking into data parallel streams, then joining such data parallel streams. Pipeline parallelism can be achieved by chaining multiple PCUs 902 together to fuse operations and increase operational intensity.

In RDU tile 802-3, PMUs 904 can provide on-chip memory capacity, throughput bandwidth, and addressing flexibility for efficient operator fusion. PMUs 904 an be used to store on-chip tensors like inputs, parameters, metadata, and intermediate results. In particular embodiments, PMU 904 can include the following components:
Scratchpad memory: Each PMU 904 may contain a programmer-managed scratchpad memory that can include a static random access memory (SRAM) array. The SRAM array used for the scratchpad memory may collectively support concurrent writes and reads.
Arithmetic logic unit (ALU) pipeline: PMU 904 may contain several stages of scalar integer ALUs that can be configured to generate read and write addresses concurrently to flexibly access a tensor in the scratchpad memory. PMU ALUs may implement a set of special complex instructions, such as bitfield extraction and shift-and-set, that may often be used in address computations. This instruction support may produce complex addresses efficiently and allow for reducing a number of ALU stages, thereby also reducing latency. The ALU pipeline can also include a path to ingest scalars as operands from RDN 906, and output computed values as scalars back to RDN 906. The ALU pipeline path can allow enhanced addressing composability. For example, complex integer calculations can be broken up and mapped across several PMUs 904 as desired. It has been observed that stage buffers in a spatially fused kernel involve concurrent reads and writes, which may have different access patterns. Certain intermittent scenarios have been observed in write and read access patterns for a tensor that inversely affect each access pattern's complexity (e.g., a relatively complex write access pattern often enables a relatively simpler read access pattern and vice versa). The ALU pipeline can allow software to exploit this observed behavior in write and read access patterns. For example, in some embodiments, the ALU pipeline can be partitioned into independent read and write address generation pipelines with a software-configured number of stages allocated to each type of access.
Address predication and banking: It has been shown that a single logical tensor can span multiple PMUs 904 due to capacity, throughput bandwidth, or both. PMU 904 can enable spanning a tensor over multiple PMUs 904 by providing hooks to programmatically control tensor address interleaving across PMUs. Specifically, PMU 904 can be programmed with a range of valid addresses for one instance of PMU 904. Alternatively, PMU 904 can support a programmable predicate bit per generated address. An address may accordingly be processed by PMU 904 if the address is within a programmed range or a valid predicate; otherwise the address may be dropped by PMU 904. Furthermore, addresses can be mapped to scratchpad banks using bank bit locations that can be programmed by software.
Data alignment unit: A data alignment unit in PMU 904 MAY support common tensor transformation operations, such as transpose, cross-lane vector permute, vector-unaligned accesses, lookup table (LUT), data format, and data layout conversions. Tensors to be transposed can be written in a special diagonally striped format across the scratchpad banks that enables reading the same tensor in both regular and transposed format at full bandwidth, which may allow for implementing the transpose operator as a read-write access pattern optimization between graph buffers.

As shown in FIG. 9, RDN 906 is a programmable interconnect on RDU tile 802 that facilitates communication between PCUs 902, PMUs 904, and AGCUs 908. RDN 906 can comprise three physical fabrics: a vector fabric, a scalar fabric, and a control fabric. The vector fabric and the scalar fabric can be packet-switched. The control fabric can be circuit-switched and can include a bundle of single bit wires that can be individually routed. The vector fabric can serve as a primary conduit for tensor data. The scalar fabric be used to transport metadata, such as an address, but in some cases can also be used to carry data or control signals. The control fabric can be used to carry control tokens for distributed coarse-grain flow control, and to collectively orchestrate the execution of a graph. Control tokens typically correspond to counter ‘done’ events that indicate the end of a loop. RDN 906 may be implemented using a mesh of non-blocking switches, as indicated by the blocks labeled RDN 906 in FIG. 9. Inbound scalar and vector packets to PCU 902/PMU 904 from RDN 906 may arrive via input FIFOs, and leave via output FIFOs. Transmissions on the vector fabric and the scalar fabric may be subject to credit-based flow control at every hop. Packet streams may also be subject to end-to-end flow control between communicating PCU 902/PMU 904 on RDN 906 through a combination of coarse-grained software tokens, fine-grained hardware credits, and forward progress guarantees in hardware. Routing tables for the vector fabric, the scalar fabric, and the control fabric may be configured by software using a place-and-route (PnR) layer within RDU compiler 522.

RDN 906 may support different types of communication patterns, including multi-cast and programmable routing and many-to-one and data reordering.
Multi-cast and programmable routing: Routing of packets on the scalar fabric and the vector fabric of RDN 906 can be done either dynamically using a 2-D dimension order route or as software-controlled static flow routing. In static flow routing, software assigns a flow ID field to a packet stream, which is carried with the packet. The flow ID field is decoded at every switch port and reassigned prior to forwarding the packet to its next destination. The static flow routing mechanism supports packet multi-casting through the switches of RDN 906.
Many-to-one and data reordering: Vector packets can contain a metadata field called sequence ID, which can be a mechanism to support arbitrary many-to-one streams in RDU tile 802. Vector output ports of PCU 902/PMU 904 can be equipped with programmable logic to generate sequence IDs for each output vector. In this manner, sequence IDs can be programmed by software to represent the logical vector order for a given operation across multiple sources. The sequence ID field can be used as an input operand in PMU 904 to compute the write addresses to reorder the packets.

As shown in FIG. 9, AGCU 908 can serve as a reconfigurable dataflow bridge for RDU tile 802 to access local device memory (HBM 710/DDR port 714), host memory 240/330, remote RDU device memory, and remote RDU tiles 802 via TLN 810. On the tile-side, AGCU 908 can operate as a dataflow core by exposing vector, scalar, and control ports of RDN 906. On the TLN-side, AGCU 908 can generate read and write requests and coalesce the responses. AGCU 908 may be equipped with a scalar address generation pipeline and counters, bearing some similarities to the logic of PMU 904, yet without having the SRAM of PMU 904. AGCU 908 can also provide an address translation layer for memory management.
P2P: AGCU 908 can support a P2P communication protocol to directly stream data between RDU tiles 802 on different instances of RDU 114 without involving DDR ports 714 or HBM 710. The P2P protocol can provide for building collective communication primitives between RDUs 114.
   Kernel launch orchestration: AGCU 908 may implement a kernel launch mechanism that can include a sequence of three commands: Program Load, Argument Load, and Kernel Execute. Running a model may involves executing a schedule of kernel launches, which can be software-orchestrated or hardware-orchestrated. Software orchestration of the kernel launches may allow more flexible scheduling of kernels and can provide more host software visibility into model execution. However, software orchestration might incur overheads that can impact performance. Hardware orchestration offloads a static kernel schedule to the dedicated hardware in AGCUs 908, which can significantly reduce overhead but might be less flexible than software orchestration.

As noted, reconfigurable dataflow architecture 100, as described herein, can be used for hardware and workload resource reservation. For example, a reservation for hardware resources may be recorded and used for allocation using RDRT architecture 600 executing on host 102 (see FIGS. 1 and 6). Specifically, in some embodiments, resource manager 622 (or RDRT driver 620) may resolve reservation of hardware resources on RDU system 110 and may record the reservation. The hardware resource reservation can then be allocated with respect to AI/ML application 510 on RDU system 110, prior to AI/ML application being executed. When multiple different (or similar) instances of AI/ML application 510 are prepared for execution on RDU system 110 at host 102, resource manager 622 (or RDRT driver 620) may coordinate and resolve any hardware conflicts among the multiple AI/ML applications 510. The developer or user of AI/ML application can also specify the hardware resources at a criteria for loading and executing AI/ML application on RDU system 110, such as by providing desired hardware resource reservations.

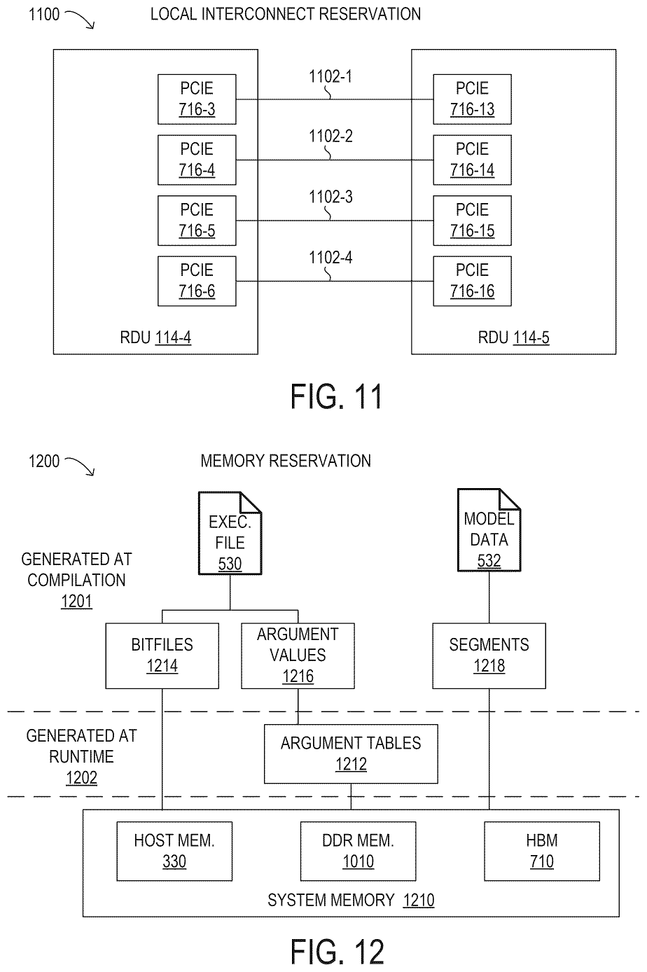

As noted, among the hardware resources subject to reservation, compute resources may include RDU tile 802, memory resources may include HBM 710 or a pair of DDR ports 714 corresponding to a DDR memory module pair, and I/O resources may include peripheral bus ports 716 corresponding to peripheral bus endpoints 804 that can be used to communicate between different RDUs 114, for example. Accordingly, by selection of a number of RDU tiles 802 that are respectively located on different RDUs 114, as described below, compute resources of a number of different RDUs 114 can be effectively reserved. When RDU tiles 802 on different RDUs 114 are reserved, I/O resources for communicating between the different RDUs are also indicated for reservation (see also FIG. 11).

The reservation of hardware resources can be provided with certain predetermined conditions that can be specifically applied to each hardware component being reserved. In particular embodiments, at least the following conditions can be applied to a reservation of a hardware resource (also referred to as an “RDU resource” herein):
shared accessibility of the RDU resource—different workloads (e.g., AI/ML applications or portions thereof) can access the RDU resource, while a higher loading (or overloading) of the RDU resource is possible, such that degraded performance at certain times may be experienced and may not be avoidable;
exclusive accessibility of the RDU resource—one or more workloads are explicitly given exclusive reservation to access the RDU resource, such that the loading of the resource is known and can be deterministic, particularly when a single workload is given exclusive reservation, and when the RDU resource is not available at the time of reservation a request to access the RDU resource may fail and the workload may be prevented from executing; and
allowed substitution of the RDU resource with a second RDU resource included in the system—when an RDU resource is requested by a workload and the RDU resource is not available for some reason at the time of reservation, a second RDU resource included in the system can be reserved in substitution, which may allow the workload to be executed.

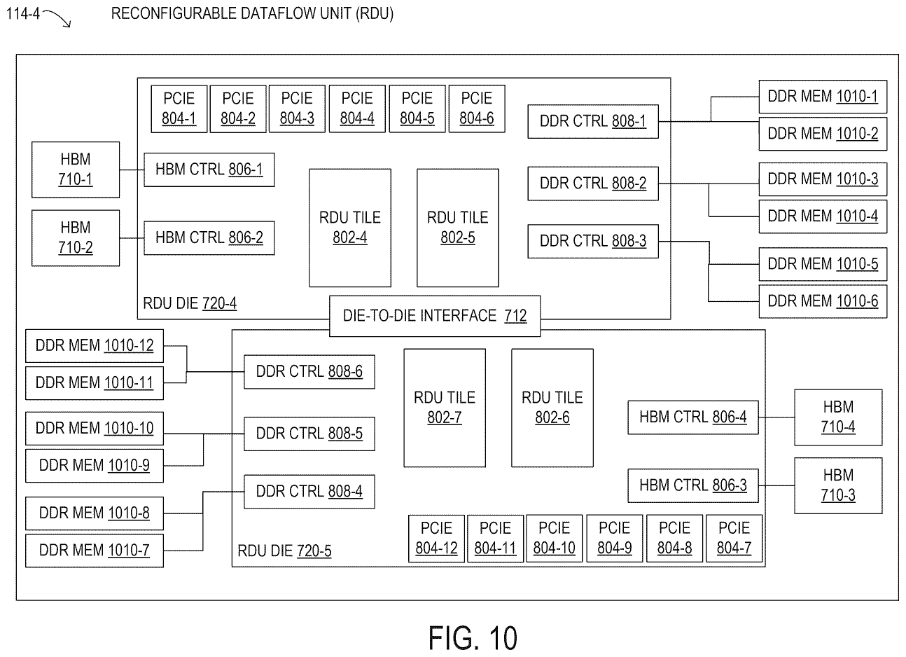

Referring now to FIG. 10, RDU 114-4 depicting further details is shown in one embodiment. FIG. 10 is a schematic illustration and is not necessarily drawn to scale or perspective. RDU 114-4 is an illustrative example for descriptive purposes that may correspond to a particular implementation on which resource reservation is shown and described in further detail. RDU 114-4 includes similar elements as shown and described with respect to RDU 114-3 in FIG. 7, but which elements are enumerated into specific numbers of instances, in the particular implementation shown in FIG. 10.

Specifically, in FIG. 10, RDU 114-4 includes RDU die 720-4 and RDU die 720-5 having D2D interface 712 therebetween. As described above, D2D interface 712 can be a high speed interface that permits communication between RDU die 720-4 and 720-5 in RDU 114-4. Accordingly, D2D interface can facilitate reservation and allocation of RDU resources within RDU 114-4, irrespective of which one or more RDU tiles 802 are used as compute resources, for example, such as by providing a transparent interface with visibility into the RDU resources in RDU 114-4. As compute resources among the RDU resources, RDU 114-4 as shown includes two (2) RDU tiles 802-4 and 802-5 on RDU die 720-4, and RDU tiles 802-6 and 802-7 on RDU die 720-5. It is noted that different numbers of RDU tiles 802 per RDU die 720 can be used in different embodiments.

In FIG. 10, as memory resources among the RDU resources, RDU 114-4 includes, at each RDU die 720, two (2) HBM controllers 806 corresponding to two (2) HBMs 710, as well as three (3) DDR memory module pairs 1010 corresponding to three (3) DDR memory controllers 808 and may accordingly correspond to DDR ports 714 that are populated with memories. Specifically, RDU die 720-4 includes HBM controllers 806-1 and 806-2 respectively coupled to HBM 710-1 and 710-2, while RDU die 720-5 includes HBM controllers 806-3 and 806-4 respectively coupled to HBM 710-3 and 710-4. Additionally, as memory resources among the RDU resources, RDU die 720-4 includes DDR controllers 808-1, 808-2, and 808-3 respectively coupled to DDR memory module pairs 1010-1/1010-2, 1010-3/1010-4, and 1010-5/1010-6, while RDU die 720-5 includes DDR controllers 808-4, 808-5, and 808-6 respectively coupled to DDR memory module pairs 1010-7/1010-8, 1010-9/1010-10, and 1010-11/1010-12.

In FIG. 10, as I/O resources among the RDU resources, RDU 114-4 includes, at each RDU die 720, six (6) PCIe endpoints 804. Specifically, RDU die 720-4 includes PCIe endpoints 804-1, 804-2, 804-3, 804-4, 804-5, and 804-6, while RDU die 720-5 includes PCIe endpoints 804-7, 804-8, 804-9, 804-10, 804-11, and 804-12. It is noted that peripheral bus ports 716 shown included with RDU 114-3 in FIG. 7 are omitted from FIG. 10 for descriptive clarity. However, it will be understood that respective PCIe ports 716 for PCIe endpoints 804 are included with RDU 114-4 in FIG. 10 (see also FIG. 11).

In operation, RDU 114-4 shown with a total of four (4) RDU tiles 802 can permit reservation of one or more RDU tiles 802 as compute resources among the RDU resources for allocation to an AI/ML application representing a workload for execution, as described above. In particular, resource manager 622 (or RDRT driver 620, see FIG. 6) at host 102 can record and maintain reservations for any RDU tiles 802 present in RDU system 110 (see FIG. 1). In one example implementation for descriptive purposes of reserving compute resources among the RDU resources, it is assumed that RDU system 110 includes four (4) xRDU elements 112, as depicted in FIG. 1 and described previously. Furthermore, it is assumed that each xRDU element 112 includes two (2) instances of RDU 114 corresponding to RDU 114-4, as shown in FIG. 10. As a result, RDU system 110 may include thirty-two (32) instances of RDU tile 802 for which reservations can be recorded and maintained by resource manager 622 (or RDRT driver 620) in this example implementation. Accordingly, resource manager 622 (or RDRT driver 620) can maintain a bitmask of available RDU tiles 802 for reservation, as shown in Table 1 below.

TABLE 1
RDU Tile Bitmask

| | TILE D1.1 | TILE D1.2 | TILE D2.1 | TILE D2.2 |
|---|---|---|---|---|
| RDU 1 | A | A | A | A |
| RDU 2 | A | A | B | B |
| RDU 3 | C | C | C/E | E |
| RDU 4 | D | D | | |
| RDU 5 | | | | |
| RDU 6 | | | | |
| RDU 7 | | | | |
| RDU 8 | | | | |

In Table 1, eight (8) RDUs 114 are labeled RDU 1-8 and correspond to a row of four (4) RDU tiles 802, of which two (2) are located respectively per two (2) RDU die 720 (labeled as D1 and D2) on each RDU 114. Table 1 shows an exemplary reservation of RDU tiles 802 for four (4) different AI/ML applications, indicated as workloads A, B, C, D in the table values. It may be assumed that workloads A, B, C, D were reserved in alphabetical order of the table values. Thus, workload A was reserved with six (6) RDU tiles 802, four (4) on RDU 1 and two (2) on RDU 2, which may minimize any communication links among the reserved RDU tiles 802. Then, at a later time, a workload B was reserved with two (2) RDU tiles 802 and was allocated tiles D2.1 and D2.2 on the same RDU die 720 on RDU 2 that were available. Then, at a later time, a workload C was reserved with three (3) RDU tiles 802 on RDU 3 under a shared availability condition, leaving tile D2.2 on RDU 3 available. Then, at a later time, a workload D was reserved with two (2) RDU tiles 802 on the same RDU die 720 for performance reasons with an exclusive accessibility condition, and was correspondingly allocated tiles D1.1 and D1.2 on RDU 4, skipping tile D2.2 on RDU3. Finally, a workload E was reserved with two (2) RDU tiles 802 and was allocated tiles D2.1 and D2.2 on RDU 3 under a shared availability condition, which resulted in workloads C and E sharing tile D2.1 on RDU 3.

FIG. 11 shows a local interconnect reservation 1100, in one embodiment. FIG. 11 is a schematic illustration and is not drawn to size or perspective. In local interconnect reservation 1100, four (4) PCIe ports 716 are shown in each of RDU 114-4 and 114-5 representing two RDU 114 in RDU system 110. Specifically, in FIG. 11, RDU 114-4 is shown including PCIe ports 716-3, 716-4, 716-5, and 716-6, while RDU 114-5 is shown including PCIe ports 716-13, 716-14, 716-15, and 716-16. Between PCIe ports 716 in FIG. 11, P2P links 1102 are shown as P2P link 1102-1 between PCIe ports 716-3 and 716-13, P2P link 1102-2 between PCIe ports 716-4 and 716-14, P2P link 1102-3 between PCIe ports 716-5 and 716-15, and P2P link 1102-4 between PCIe ports 716-6 and 716-16.

In operation, when executable file 530 (see FIG. 5) is compiled the information about different RDUs 114 and P2P links 1102 indicated therebetween can be inferred and presented as a suggestion for I/O reservations. If for some reason, certain instances of P2P links are unavailable then resource manager 622 (or RDRT driver 620) can modify or enforce certain reservation conditions and reallocate the I/O reservations, including denying execution of an AI/ML application 510 when reservation conditions cannot be fulfilled. For example, when P2P link 1102-4 is already in use, and no other P2P links 1102 between RDUs 114-4 and 114-5 are available, AI/ML application 510 can reserve P2P links 1102-1, 1102-2, and 1102-3, such as when the reservation condition is shared accessibility for at least three (3) P2P links 1102. Then during execution, when P2P link 1102-1 goes down or becomes inoperable, execution of AI/ML application 510 may fail. When the reservation condition is shared accessibility for at least two (2) P2P links 1102, the execution of AI/ML application 510 may continue with lower I/O throughput bandwidth, for example.

FIG. 12 shows a memory reservation 1200, in one embodiment. FIG. 12 is a schematic illustration and is not drawn to size or perspective. In memory reservation 1200, various data structures involved with AI/ML application are shown as being generated at compile time in 1201 or generated in runtime in 1202. In a system memory 1210, host memory 330, DDR memory 1010, and HBM 710 represent respective RDU memory resources for reservation (see FIGS. 3, 7, and 10).

Specifically, executable file 530 and model data 532 may be generated or determined at compilation. Executable file 530, as noted above, includes compiled executable instructions for RDU tiles 802 in bitfiles 1214 to implement AI/ML application 510, such as for processing one or more NN model structures. Executable file 530, as noted above, may also include argument values 1216 that may be inputs to an NN model, for example for tuning or customizing execution of bitfiles 121. Argument values 1216 may include checkpoints, weights, or bias values that are input to the compiled NN model structure during execution on RDU tiles 802. At runtime, argument values 1216 may be transformed into argument tables 1212 that can be used by RDU tiles 802. As noted model data 532 can describe one or more NN model structures associated with bitfiles 1214, and therefore, can describe very large NN models. For this reason, model data 532 can be broken down or subdivided into segments 1218 that are used during execution.

In FIG. 12, memory reservation 1200 shows that bitfiles 1214, argument table 1212, and segments 1218 may represent data that is stored for execution of AI/ML application 510 and which can be reserved for storage using host memory 330, DDR memory 1010, and HBM 710, with respectively increasing performance levels. In this manner, the execution performance of workload memory associated with AI/ML model can be selected and reserved for allocation during execution, as described herein. In some embodiments, a reservation for a given type of system memory 1210 may be predetermined based on data origin as shown in memory reservation 1200 and may be globally defined for AI/ML applications 510 executing using RDU system 110.

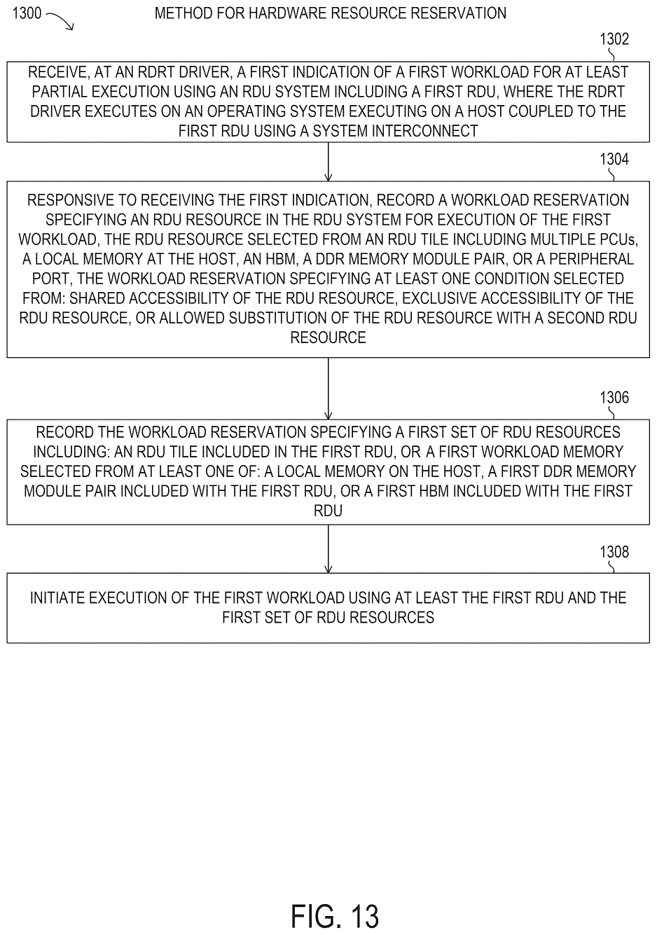

Referring now to FIG. 13, a flowchart of selected elements of an embodiment of a method 1300 for hardware resource allocation in reconfigurable dataflow architecture 100, as described herein, is depicted. Method 1300 may be performed using various hardware and software elements in reconfigurable dataflow architecture 100, as described above. In particular embodiments, at least certain portions of method 1300 may be performed using RDRT driver 620, such as by resource manager 622, as described with respect to FIGS. 11 and 12, for example. It is noted that certain operations described in method 1300 may be optional or may be rearranged in different embodiments.

Method 1300 may begin at step 1302 by receiving, at an RDRT driver, a first indication of a first workload for at least partial execution using an RDU system including a first RDU, where the RDRT driver executes on an operating system executing on a host coupled to the first RDU using a system interconnect. At step 1304, responsive to receiving the first indication, a workload reservation specifying an RDU resource can be recorded in the RDU system for execution of the first workload, the RDU resource selected from an RDU tile including multiple PCUs, a local memory at the host, an HBM, a DDR memory module pair, or a peripheral port, the workload reservation specifying at least one condition selected from: shared accessibility of the RDU resource, exclusive accessibility of the RDU resource, or allowed substitution of the RDU resource with a second RDU resource. At step 1306, the workload reservation is recorded specifying a first set of RDU resources including: an RDU tile included in the first RDU, or a first workload memory selected from at least one of: a local memory on the host, a first DDR memory module pair included with the first RDU, or a first HBM included with the first RDU. At step 1308, execution of the first workload is initiated using at least the first RDU and the first set of RDU resources.

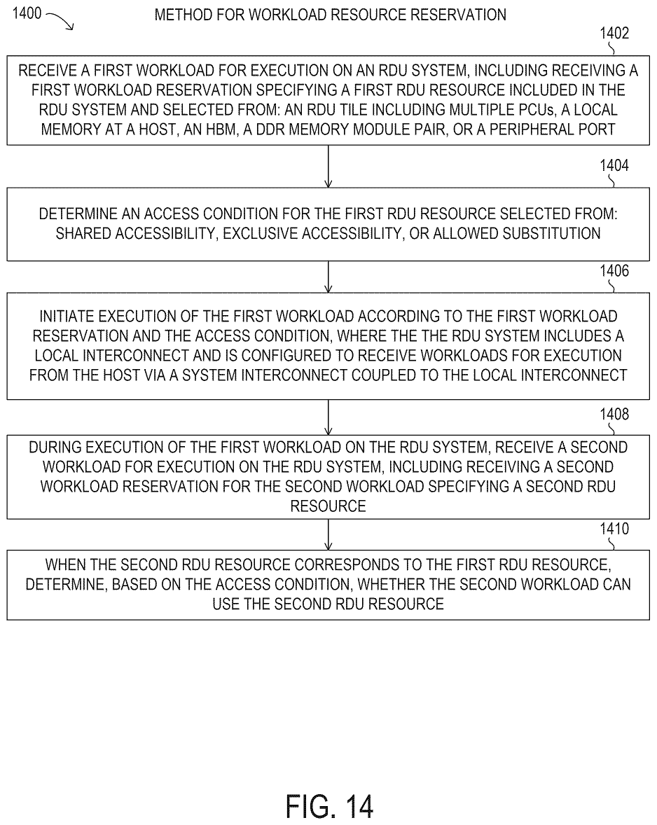

Referring now to FIG. 14, a flowchart of selected elements of an embodiment of a method 1400 for workload resource allocation in reconfigurable dataflow architecture 100, as described herein, is depicted. Method 1400 may be performed using various hardware and software elements in reconfigurable dataflow architecture 100, as described above. In particular embodiments, at least certain portions of method 1400 may be performed using RDRT driver 620, such as by resource manager 622, as described with respect to FIGS. 11 and 12, for example. It is noted that certain operations described in method 1400 may be optional or may be rearranged in different embodiments.

Method 1400 may begin at step 1402 by receiving a first workload for execution on an RDU system, including receiving a first workload reservation specifying a first RDU resource included in the RDU system and selected from: an RDU tile including multiple PCUs, a local memory at a host, an HBM, a DDR memory module pair, or a peripheral port. At step 1404, an access condition is determined for the first RDU resource selected from: shared accessibility, exclusive accessibility, or allowed substitution. At step 1406, execution of the first workload is initiated according to the first workload reservation and the access condition, where the RDU system includes a local interconnect and is configured to receive workloads for execution from the host via a system interconnect coupled to the local interconnect. At step 1408, during execution of the first workload on the RDU system, a second workload is received for execution on the RDU system, including receiving a second workload reservation for the second workload specifying a second RDU resource. At step 1410, when the second RDU resource corresponds to the first RDU resource, based on the access condition, it is determined whether the second workload can use the second RDU resource.

As disclosed herein, a system includes a first RDU including a local interconnect usable for coupling to a second RDU, a host coupled to the first RDU using a system interconnect coupled to the local interconnect, and a local memory on the host. The system interconnect is accessed by a RDRT driver running on the host. The RDRT driver may record a workload reservation specifying an RDU resource usable to execute a workload, selected from: an RDU tile, a local host memory, an HBM, a DDR memory, or a peripheral port. The reservation specifies a condition of shared accessibility, exclusive accessibility, or allowed substitution of the RDU resource with a second RDU resource The workload can include an AI/ML application for execution by the system.

As disclosed herein, an RDU system includes a local interconnect and may receive workloads for execution from a host via a system interconnect coupled to the local interconnect, and an RDRT architecture executing on the host. The RDRT architecture may be configured to receive a first workload for execution on the RDU system and receive a first workload reservation specifying a first RDU resource included in the RDU system and selected from: an RDU tile including multiple PCUs, a local memory at the host, an HBM, a DDR memory module pair, or a peripheral port. The RDRT architecture may also be configured to determine an access condition for the first RDU resource selected from: shared accessibility, exclusive accessibility, or allowed substitution, and initiate execution of the first workload according to the first workload reservation and the access condition.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system comprising:
a first reconfigurable dataflow unit (RDU) including a local interconnect usable for coupling to a second RDU;
a host coupled to the first RDU using a system interconnect coupled to the local interconnect, wherein the system interconnect is accessed by a reconfigurable dataflow runtime (RDRT) driver executing under an operating system running on the host;
a local memory on the host;
wherein the RDRT driver is configured to:
record a workload reservation specifying an RDU resource usable to execute a workload by the system, the RDU resource selected from: an RDU tile including multiple pattern compute units (PCUs), a local memory at the host, a high-bandwidth memory (HBM), a dual data rate (DDR) memory module pair, or a peripheral port, the workload reservation specifying at least one condition selected from:
shared accessibility of the RDU resource,
exclusive accessibility of the RDU resource, or
allowed substitution of the RDU resource with a second RDU resource included in the system,
wherein the workload includes an artificial intelligence (AI)/machine learning (ML) application for execution using the system.

2. The system of claim 1, wherein the RDRT driver is further configured to:
receive a first indication for at least partial execution of the workload using the first RDU;
responsive to receiving the first indication, record the workload reservation specifying that the RDU resource includes:
an RDU tile included in the first RDU; and
a first memory selected from at least one of:
the local memory,
a DDR memory module pair, or
an HBM.

3. The system of claim 2, further comprising:
a first RDU tile and a second RDU tile included with the first RDU;
a first set of DDR memory module pairs included with the first RDU;
a first HBM and a second HBM included with the first RDU;
a first plurality of peripheral ports included with the local interconnect in the first RDU;
a second plurality of peripheral ports included with the local interconnect in the second RDU;
a third RDU tile and a fourth RDU tile included in the second RDU;
a second set of DDR memory module pairs included with the second RDU; and
a third HBM and a fourth HBM included with the second RDU,
wherein the RDRT driver is configured to:
receive a second indication for at least partial execution of the workload using the first RDU and using the second RDU;
responsive to receiving the second indication, record the workload reservation specifying that the RDU resource includes:
an RDU tile included in the first RDU or in the second RDU;
a pair of peripheral ports including one of the first plurality of peripheral ports and one of the second plurality of peripheral ports; and
a second memory selected from at least one of:
the local memory,
a DDR memory module pair included with the first RDU or the second RDU, or
an HBM included with the first RDU or the second RDU.

4. The system of claim 3, wherein the first RDU further comprises a first RDU die including:
the first RDU tile,
the second RDU tile,
about one half of the first plurality of peripheral ports,
a first HBM controller controlling the first HBM,
a second HBM controller controlling the second HBM, and
a first set of DDR controllers respectively controlling about one half of the first set of DDR memory module pairs.

5. The system of claim 4, wherein the first RDU further comprises:
a second RDU die linked to the first RDU die with a die-to-die (D2D) interface, wherein the second RDU die includes corresponding components as the first RDU die, or wherein the second RDU die is identical to the first RDU die.

6. The system of claim 1, wherein the shared accessibility of the RDU resource specifies sharing of the RDU resource among the workload and a second workload concurrently executing on the system.

7. The system of claim 6, wherein the exclusive accessibility of the RDU resource specifies that a second workload for execution on the system, concurrently to the workload, will be denied access to the RDU resource.

8. A method comprising:
receiving, at a reconfigurable dataflow runtime (RDRT) driver, a first indication of a first workload for at least partial execution using a reconfigurable dataflow unit (RDU) system including a first RDU, wherein the RDRT driver executes on an operating system executing on a host coupled to the first RDU using a system interconnect; and
responsive to receiving the first indication, recording a workload reservation specifying an RDU resource in the RDU system for execution of the first workload, the RDU resource selected from an RDU tile including multiple pattern compute units (PCUs), a local memory at the host, a high-bandwidth memory (HBM), a dual data rate (DDR) memory module pair, or a peripheral port, the workload reservation specifying at least one condition selected from:
shared accessibility of the RDU resource,
exclusive accessibility of the RDU resource, or
allowed substitution of the RDU resource with a second RDU resource,
wherein the first workload includes an artificial intelligence (AI)/machine learning (ML) application for execution using the RDU system.

9. The method of claim 8, further comprising:
recording the workload reservation specifying a first set of RDU resources including:
an RDU tile included in the first RDU, or
a first workload memory selected from at least one of: a local memory on the host, a first DDR memory module pair included with the first RDU, or a first HBM included with the first RDU; and
initiating execution of the first workload using at least the first RDU and the first set of RDU resources.

10. The method of claim 9, wherein the first RDU further comprises:
a first plurality of peripheral ports included in a local interconnect coupled to the system interconnect, and
wherein the method further comprises:
receiving, at the RDRT driver, a second indication of the first workload for execution using the first RDU and using a second RDU coupled with the first RDU using the local interconnect;
responsive to receiving the second indication, recording the workload reservation specifying a second set of RDU resources including:
an RDU tile included in the first RDU or in the second RDU,
a second workload memory selected from at least one of: the local memory, a second DDR memory module pair included with the first RDU or the second RDU, or a second HBM included with the first RDU or the second RDU, or
a pair of peripheral ports consisting of one of the first plurality of peripheral ports coupled to one of a second plurality of peripheral ports included with the local interconnect in the second RDU; and
initiating execution of the first workload according to the workload reservation using the first RDU, the second RDU, and the second set of RDU resources.

11. The method of claim 10, wherein the first RDU further comprises a first RDU die including:
a first RDU tile,
a second RDU tile,
about one half of the first plurality peripheral ports,
a first HBM controller,
a second HBM controller, and
a first set of DDR controllers respectively controlling about one half of the first set of DDR memory module pairs.

12. The method of claim 11, wherein the first RDU further comprises:
a second RDU die linked to the first RDU die with a die-to-die (D2D) interface, wherein the second RDU die includes corresponding components as the first RDU die, or wherein the second RDU die is identical to the first RDU die.

13. The method of claim 8, wherein recording the workload reservation specifying the shared accessibility of the RDU resource further comprises:
recording the workload reservation specifying sharing of the RDU resource among the first workload and a second workload concurrently executing on the RDU system.

14. The method of claim 8, wherein recording the workload reservation specifying the exclusive accessibility of the RDU resource further comprises:
recording the workload reservation specifying that a second workload for execution on the system, concurrently to the first workload, will be denied access to the RDU resource.

15. Tangible computer-readable media comprising instructions executable by a computer system to:
receive, at a reconfigurable dataflow runtime (RDRT) driver, a first indication of a first workload for at least partial execution using a reconfigurable dataflow unit (RDU) system including a first RDU, wherein the RDRT driver executes on an operating system executing on a host coupled to the first RDU using a system interconnect;
responsive to receiving the first indication, record a workload reservation specifying an RDU resource in the RDU system for execution of the first workload, the RDU resource selected from an RDU tile including multiple pattern compute units (PCUs), a local memory at the host, a high-bandwidth memory (HBM), a dual data rate (DDR) memory module pair, or a peripheral port, the workload reservation specifying at least one condition selected from:
shared accessibility of the RDU resource,
exclusive accessibility of the RDU resource, or
allowed substitution of the RDU resource with a second RDU resource,
wherein the first workload includes an artificial intelligence (AI)/machine learning (ML) application for execution using the RDU system.

16. The computer-readable media of claim 15, further comprising instructions to:
record the workload reservation specifying a first set of RDU resources including:
an RDU tile included in the first RDU, or
a first workload memory selected from at least one of: a local memory on the host, at least one first DDR memory module pairs included with the first RDU, or a first HBM included with the first RDU; and
initiating execution of the first workload using the first RDU and the first set of RDU resources.

17. The computer-readable media of claim 16, wherein the first RDU further comprises:
a first plurality of peripheral ports included in a local interconnect coupled to the system interconnect, and
further comprising instructions to:
receive, at the RDRT driver, a second indication of the workload for execution using the first RDU and using a second RDU coupled with the first RDU using the local interconnect;
responsive to receiving the second indication, record the workload reservation specifying a second set of RDU resources including:
an RDU tile included in the first RDU or in the second RDU, or
a second workload memory selected from at least one of: the local memory, a second DDR memory module pair included with the first RDU or the second RDU, or a second HBM included with the first RDU or the second RDU, or a pair of peripheral ports consisting of one of the first plurality of peripheral ports coupled to one of a second plurality of peripheral ports included with the local interconnect in the second RDU; and
initiate execution of the first workload according to the workload reservation using the first RDU, the second RDU, and the second set of RDU resources.

18. The computer-readable media of claim 17, wherein the first RDU further comprises a first RDU die including:
a first RDU tile,
a second RDU tile,
about one half of the first plurality peripheral ports,
a first HBM controller,
a second HBM controller,
a first set of DDR controllers respectively controlling about one half of the first set of DDR memory module pairs, and
wherein the first RDU further comprises:
a second RDU die linked to the first RDU die with a die-to-die (D2D) interface, wherein the second RDU die includes corresponding components as the first RDU die, or wherein the first RDU die is identical to the second RDU die.

19. The computer-readable media of claim 15, wherein the instructions to record the workload reservation specifying the shared accessibility of the RDU resource further comprise instructions to:
record the workload reservation specifying sharing of the RDU resource among the first workload and a second workload concurrently executing on the RDU system.

20. The computer-readable media of claim 15, wherein the instructions to record the workload reservation specifying the exclusive accessibility of the RDU resource further comprise instructions to:
record the workload reservation specifying that a second workload for execution on the RDU system, concurrently to the first workload, will be denied access to the RDU resource.
